(19) United States
(12) Patent Application Publication
(10) Pub. No.: US 2024/0054481 A1
(43) Pub. Date: Feb. 15, 2024

(54) Content Rights Management Systems and Methods Using Trusted Ledgers

(71) Applicant: Intertrust Technologies Corporation, Milpitas, CA (US)

(72) Inventor: Yutaka Nagao, Sunnyvale, CA (US)

(73) Assignee: Intertrust Technologies Corporation, Milpitas, CA (US)

(21) Appl. No.: 18/232,561

(22) Filed: Aug. 10, 2023

Related U.S. Application Data
(60) Provisional application No. 63/396,876, filed on Aug. 10, 2022.

(51) Int. Cl. G06Q 20/36

(52) U.S. Cl. CPC G06Q 20/3674; G06Q 2220/18

(57) ABSTRACT

Embodiments of the disclosed systems and methods may facilitate various rights management and/or digital content operations in connection with a variety of transactions. Various embodiments may leverage non-fungible tokens in connection with content asset management. For example and without limitation, various embodiments provide for the creation of token associated with content assets, secure association of creator, author, and/or other rightsholder information with content assets, creation and/or management of certain business conditions, contracts, and/or agreements associated with content assets, and/or listing of content assets in connection with a marketplace, and/or the like. In some implementations, these operations and/or aspects thereof may facilitate compensation of rights holder(s) associated with content assets.

### CROSS-REFERENCE TO RELATED APPLICATIONS

This application claims the benefit of priority under 35 U.S.C. § 119(e) to U.S. Provisional Application No. 63/396,876, filed Aug. 10, 2022, and entitled “SYSTEMS AND METHODS FOR CONTENT RIGHTS MANAGEMENT,” which is hereby incorporated by reference in its entirety.

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### SUMMARY OF THE INVENTION

The present disclosure relates generally to systems and methods for managing content rights. More specifically, but not exclusively, the present disclosure relates to systems and methods for managing content rights using non-fungible tokens (“NFTs”) associated with content in a marketplace leveraging trusted ledgers.

An NFT is a type of cryptographic token on a trusted distributed ledger (e.g., a blockchain ledger) that may represent a digital asset. NFTs may be used in a variety of contexts, with applications varying from simple digital asset transactions to complex collateral loans. Consistent with embodiments disclosed herein, an NFT may be associated with a content asset and/or rights associated with content.

Embodiments of the systems and methods may use an improved service-based system for managing digital assets. Metadata associated with digital assets may be stored in a server database, and the correlation of digital assets and associated metadata may be securely stored in a trusted ledger, such as a blockchain ledger. Embodiments of the disclosed systems and methods may use digital rights management (“DRM”) technology in connection with NFT management paradigms. For example and without limitation, using various aspects of the disclosed systems and methods, a customer can listen to purchased content, such as a purchased song, but they may not be able to download the content and/or upload it on other platforms in violation of their rights to the content, because the purchased content may be protected with DRM and/or other enforceable content parameters.

In various disclosed embodiments, trusted databases, ledgers, and/or the like (which may be generally referred to herein as “trusted ledgers” and/or variations of the same), may be used to record and/or otherwise manage various assertions associated with electronic content and/or NFTs. In some embodiments, such databases and/or ledgers may be distributed, and may be referred to herein as trusted immutable distributed assertion ledgers (“TIDALs”) and/or variations of the same. In some embodiments, trusted ledgers may comprise blockchain ledgers.

Databases and/or ledgers may, in various embodiments, be public, private, and/or a combination thereof. In certain embodiments, a TIDAL may comprise a public indelible distributed database (“PIDD”). TIDALs consistent with various aspects of the disclosed embodiments may be associated with a variety of properties including, for example, ledger processes that may be resistant to byzantine failures, entries that may be immutable and/or relatively immutable, entries that may be time-synced (at least in part), entries that may be scalable, and/or entries that may be available for relatively fast lookup.

Embodiments of the disclosed systems and methods may facilitate various rights management and/or digital content operations in connection with a variety of NFT transactions. These may include, for example and without limitation, creation of NFTs associated with digital content and/or content assets, secure association of creator, author, and/or other rightsholder information with digital content, creation and/or management of certain business conditions, parameters, contracts, and/or agreements associated with digital content, listing of digital content in connection with a marketplace, and/or the like. In some implementations, these operations and/or aspects thereof may facilitate compensation of rights holder(s) associated with digital content. In certain embodiments, one or more commercial blockchain ledgers may be employed such as, for example, the FLOW blockchain, and blockchain connector and/or integration services may provide mechanisms to readily implement aspects of the disclosed systems and methods with such established blockchain architectures.

### BRIEF DESCRIPTION OF DRAWINGS

The inventive body of work will be readily understood by referring to the following detailed description in conjunction with the accompanying drawings, in which:

FIG. 1A illustrates a first part of a non-limiting example of a process for creating a song asset in connection with a token management service consistent with certain embodiments disclosed herein.

FIG. 1B illustrates a second part of a non-limiting example of a process for creating a song asset in connection with a token management service consistent with certain embodiments disclosed herein.

FIG. 1C illustrates a third part of a non-limiting example of a process for creating a song asset in connection with a token management service consistent with certain embodiments disclosed herein.

FIG. 1D illustrates a fourth part of a non-limiting example of a process for creating a song asset in connection with a token management service consistent with certain embodiments disclosed herein.

FIG. 2A illustrates a first part of a non-limiting example of a process for updating a song in connection with a token management service consistent with certain embodiments disclosed herein.

FIG. 2B illustrates a second part of a non-limiting example of a process for updating a song in connection with a token management service consistent with certain embodiments disclosed herein.

FIG. 2C illustrates a third part of a non-limiting example of a process for updating a song in connection with a token management service consistent with certain embodiments disclosed herein.

FIG. 2D illustrates a fourth part of a non-limiting example of a process for updating a song in connection with a token management service consistent with certain embodiments disclosed herein.

FIG. 3A illustrates a first part of a non-limiting example of a process for adding and/or removing a co-writer in connection with a token management service consistent with certain embodiments disclosed herein.

FIG. 3B illustrates a second part of a non-limiting example of a process for adding and/or removing a co-writer in connection with a token management service consistent with certain embodiments disclosed herein.

FIG. 3C illustrates a third part of a non-limiting example of a process for adding and/or removing a co-writer in connection with a token management service consistent with certain embodiments disclosed herein.

FIG. 4A illustrates a first part of a non-limiting example of a process for inviting and/or disinviting a friend to a access and/or otherwise interact with a song in connection with a token management service consistent with certain embodiments disclosed herein.

FIG. 4B illustrates a second part of a non-limiting example of a process for inviting and/or disinviting a friend to a access and/or otherwise interact with a song in connection with a token management service consistent with certain embodiments disclosed herein.

FIG. 4C illustrates a third part of a non-limiting example of a process for inviting and/or disinviting a friend to a access and/or otherwise interact with a song in connection with a token management service consistent with certain embodiments disclosed herein.

FIG. 5A illustrates a first part of a non-limiting example of a process for playing back a song in connection with a token management service consistent with certain embodiments disclosed herein.

FIG. 5B illustrates a second part of a non-limiting example of a process for playing back a song in connection with a token management service consistent with certain embodiments disclosed herein.

FIG. 5C illustrates a third part of a non-limiting example of a process for playing back a song in connection with a token management service consistent with certain embodiments disclosed herein.

FIG. 6A illustrates a first part of a non-limiting example of a process for creating a contract in connection with a token management service consistent with certain embodiments disclosed herein.

FIG. 6B illustrates a second part of a non-limiting example of a process for creating a contract in connection with a token management service consistent with certain embodiments disclosed herein.

FIG. 6C illustrates a third part of a non-limiting example of a process for creating a contract in connection with a token management service consistent with certain embodiments disclosed herein.

FIG. 7A illustrates a first part of a non-limiting example of a process for sharing a contract in connection with a token management service consistent with certain embodiments disclosed herein.

FIG. 7B illustrates a second part of a non-limiting example of a process for sharing a contract in connection with a token management service consistent with certain embodiments disclosed herein.

FIG. 7C illustrates a third part of a non-limiting example of a process for sharing a contract in connection with a token management service consistent with certain embodiments disclosed herein.

FIG. 8A illustrates a first part of a non-limiting example of a process for editing a contract in connection with a token management service consistent with certain embodiments disclosed herein.

FIG. 8B illustrates a second part of a non-limiting example of a process for editing a contract in connection with a token management service consistent with certain embodiments disclosed herein.

FIG. 8C illustrates a third part of a non-limiting example of a process for editing a contract in connection with a token management service consistent with certain embodiments disclosed herein.

FIG. 9A illustrates a first part of a non-limiting example of a process for signing a contract in connection with a token management service consistent with certain embodiments disclosed herein.

FIG. 9B illustrates a second part of a non-limiting example of a process for signing a contract in connection with a token management service consistent with certain embodiments disclosed herein.

FIG. 9C illustrates a third part of a non-limiting example of a process for signing a contract in connection with a token management service consistent with certain embodiments disclosed herein.

FIG. 9D illustrates a fourth part of a non-limiting example of a process for signing a contract in connection with a token management service consistent with certain embodiments disclosed herein.

FIG. 10A illustrates a first part of a non-limiting example of a process for listing a content asset in a marketplace in connection with a token management service consistent with certain embodiments disclosed herein.

FIG. 1013 illustrates a second part of a non-limiting example of a process for listing a content asset in a marketplace connection with a token management service consistent with certain embodiments disclosed herein.

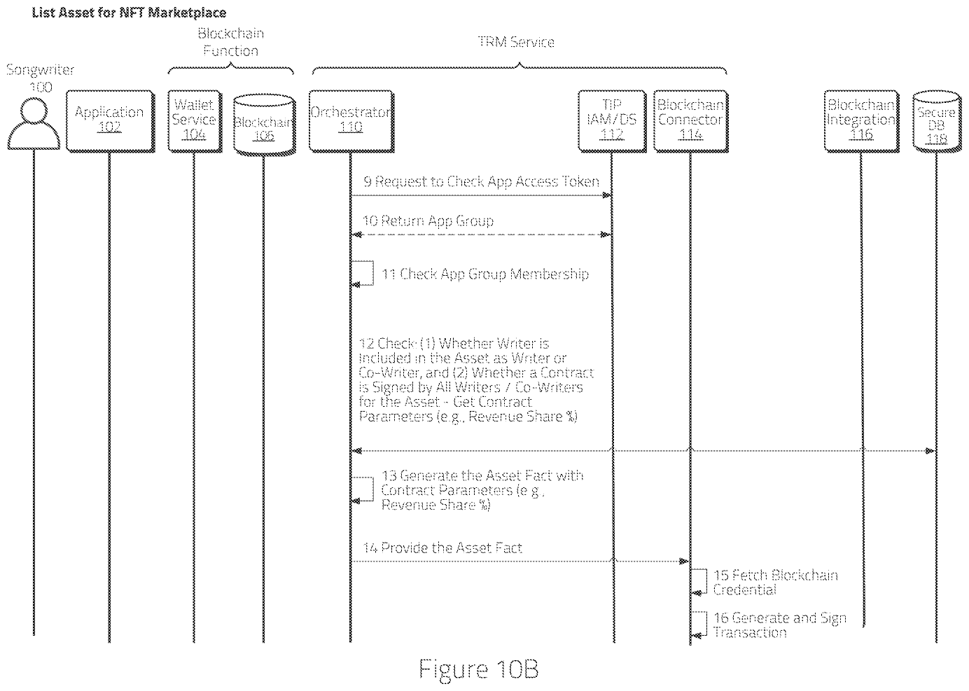

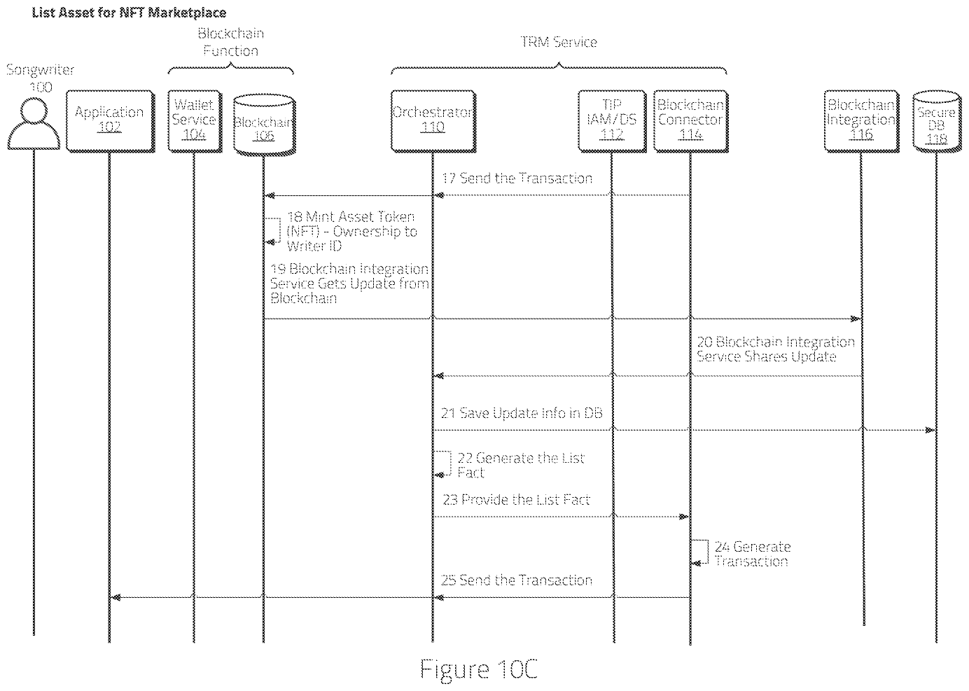

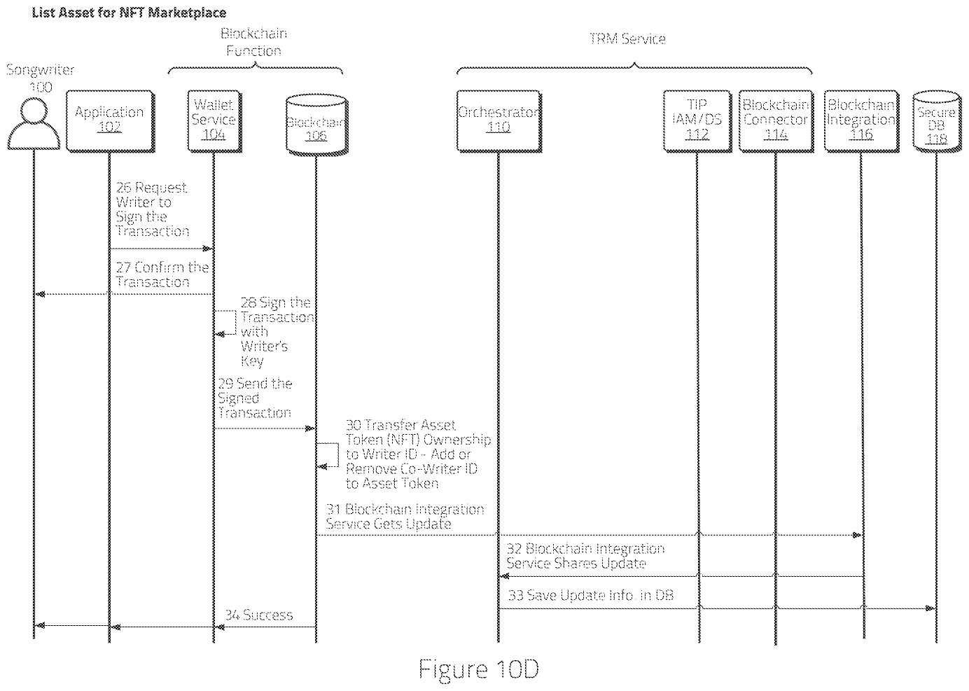

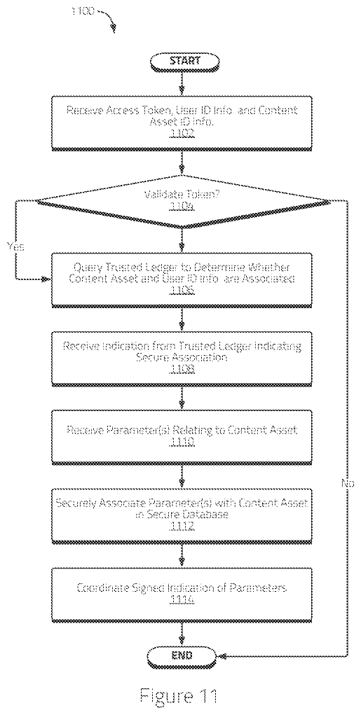

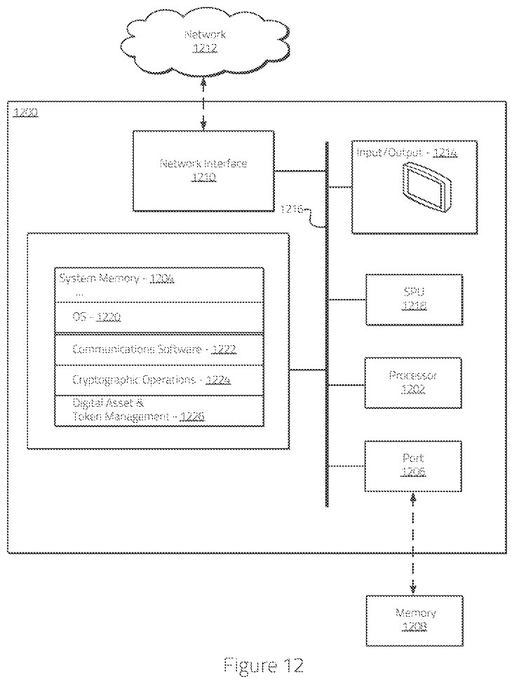

FIG. 10C illustrates a third part of a non-limiting example of a process for listing a content asset in a marketplace connection with a token management service consistent with certain embodiments disclosed herein.

FIG. 10D illustrates a fourth part of a non-limiting example of a process for listing a content asset in connection with a token management service consistent with certain embodiments disclosed herein.

FIG. 11 illustrates a flow chart of a non-limiting example of a method for managing a content asset consistent with certain embodiments disclosed herein.

FIG. 12 illustrates an example of a system that may be used to implement certain embodiments of the systems and methods of the present disclosure.

### DETAILED DESCRIPTION OF THE INVENTION

A description of systems and methods consistent with embodiments of the present disclosure is provided herein. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to certain drawings. The components of the disclosed embodiments, as generally described and/or illustrated in the figures herein, could be arranged and designed in a wide variety of different configurations. Thus, the following description of the embodiments of the systems and methods of the disclosure is not intended to limit the scope of the disclosure, but is merely representative of possible embodiments of the disclosure. In addition, the steps of any method disclosed herein do not necessarily need to be executed in any specific order, or even sequentially, nor need the steps be executed only once, unless otherwise specified.

Embodiments of the disclosed systems and methods may provide for dynamic management of digital content, products, and/or associated NFTs in a secure way, where the rights of rights holders in such assets, products, and/or NFTs are definable in a manner such that they can be respected and/or otherwise enforced. Although various embodiments and examples disclosed herein may relate to audio and/or song content, it will be appreciated that the disclosed systems and methods and aspects thereof are not so limited and, indeed, may be employed in connection with a variety of types of content and/or data including, for example and without limitation, audio content, video content, multimedia content, software, data (which may comprise proprietary data and/or databases), and/or the like. In this manner, the terms “content”, “asset”, and/or derivatives as used herein thereof should be considered to encompass a relatively broad variety of possible types of content and/or data.

Various embodiments disclosed herein may use trusted ledgers to securely record certain assertions relating to the digital content, products, rightsholders, and/or various ecosystem participants. Such assertions may be used in connection with rights binding, content packaging, management, and/or protection operations in connection with a variety of transactions associated with digital assets, products, and/or associated NFTs.

Certain aspects of the disclosed processes may be performed by and/or otherwise in connection with one or more entities, services, and/or systems that may include, for example and without limitation, one or more of:
Application (“App”) —A software application execution on a device and/or system that may be used to interact with embodiments of the disclosed token management service. In certain embodiments, the application may be part of marketplace service, which may be associated with the same or a separate system and/or service than the token management service.
Blockchain Function—A service that may offer a trusted ledger such as a blockchain, which may be private, public, and/or combinations of private and/or public. In some embodiments, the blockchain may comprise a TIDAL and/or another suitable trusted ledger service that may be provided by a trusted data management platform (“TIP”) service and/or another service or entity. Although various examples described herein may use a TIDAL, it will be appreciated that various embodiments and aspects of the disclosed systems and methods may be implemented using a variety of other trusted databases, ledgers, and/or blockchains that may, or may not, have certain attributes associated with a TIDAL. As used herein, a TIDAL may generally describe an assertion ledger having certain properties of a TIDAL as detailed herein (and/or a subset thereof), and in some instances may describe a TIDAL with entries derived and/or otherwise generated based on entries in one or more other ledgers and/or TIDALs, which in some instances may be referred to alternatively and/or additionally as a derivative TIDAL. The blockchain function service may further offer a wallet service function, although it will be appreciated that in some embodiments, the wallet service may be implemented by a separate and/or otherwise different service and/or system.
Package Function Service—A service that may be used to package content and/or media and/or store the same. In some embodiments, the package function service may comprise a media packager service and/or cloud object storage functionality.
Token and/or Token Rights Management (“TRM”) Service—A system and/or service that may use a TIP service for NFT and/or DRM implementations. The TRM service may include and/or otherwise implement a service orchestrator, an Identity and Access Management (“IAM”) service, a directory service (“DS”), and/or a blockchain connector service for interfacing with a trusted ledger and/or a secure database implementing a trusted ledger, which in some embodiments may comprise a blockchain ledger. In certain embodiments, the TRM service may interface with the secure database and/or the blockchain via an intermediary blockchain integration service (e.g., Graffle). The TRM System may further implement and/or otherwise include DRM and/or key management services (“KMS”) for managing content and/or associated rights and/or keys (e.g., ExpressPlay).

Various embodiments of the disclosed systems and methods may provide mechanisms for the creation, sharing, agreement of terms and/or conditions of digital content by creators, listing of content in an NFT marketplace, and distribution of content via an NFT marketplace. Creators may create digital content by themselves and/or other co-creators and upload the assets to a creator platform. Creators may choose between a new title or an update to an existing title when uploading digital content.

In some embodiments, creators may have their digital assets in the process of creation viewed by stakeholders (e.g., colleagues) other than co-authors and receive feedback. For example, in some implementations, a creator may select a title to be viewed by a friend and then may select the friend to allow for viewing of the title. A person (e.g., a colleague) who has shared digital assets may be shown via an appropriate interface where a user can select and view a title shared with them via an appropriate menu.

In certain embodiments, creators may add their peers to creators of digital assets depending on their feedback. When a digital asset is completed, the creator may, for example and without limitation, invite a lawyer, create a contract, and discuss and agree on profit sharing among the co-authors who created the digital asset. This may be supported, at least in part, by a creator interaction with an interface for creating a contract for a version of a digital asset.

Creators may list digital assets that have been agreed upon by the co-creators to the NFT marketplace for distribution. At that time, the creator who is the seller may decide how to sell (e.g., number of sales, viewing rights only, both viewing rights and sales rights, etc.) and/or price. For example, in some implementations, a creator may determine a selling price, a rental period, and/or auction conditions for digital assets to be exhibited on an NFT marketplace.

Consumers may purchase usage rights (e.g., viewing and/or listening rights, etc.) and/or sales rights of NFT digital assets listed on the NFT marketplace according to a listing price and, in some cases, view through secondary distribution, trade rights, and/or distribution rights. Transactions in the primary and/or secondary distribution of the NFT marketplace may be recorded on the blockchain, which may allow creators to trace their contents. Based on transactions in the primary and secondary digital asset distribution markets, creators, and/or their co-creators may receive (e.g., automatically receive) profit sharing based on the contract agreed on the creator platform.

In the process of creating digital assets, various versions may be created. Since the creator of each version may not be managed in conventional content management platforms, the copyright owner may be ambiguous. Plagiarism may be more likely to occur because viewing rights of digital assets in the creative process may not be properly protected. For digital assets, since the terms and/or conditions of content may not necessarily be managed among co-creators in conventional platforms, it may become difficult to determine where the copyright is located and the distribution of profits.

Consistent with embodiments disclosed herein, the disclosed systems and methods may securely manage who is the creator of each version of a digital asset in the process of creation. When sharing digital assets with related parties (e.g., colleagues) in the process of creation, content may be protected and/or access management techniques may be implemented using DRM services to prevent unauthorized access and/or theft. Embodiments of the disclosed systems and methods may further electronically create and store contracts and/or association of content related parameters to clarify profit sharing among co-creators of content and/or other stakeholders.

In many conventional content management platforms, there may not be significant coordination between the creation process of digital assets and safe primary and/or secondary distribution of such assets. In such circumstances, pirated copies may be distributed because it may not be properly confirmed whether the seller is the author of the digital assets when they are listed on a marketplace, reducing the value of such assets. Moreover, if profits are obtained on the primary and/or secondary distribution in conventional marketplaces, the terms of the agreement between the co-creators agreed upon in the creation process may not be transparently implemented.

Embodiments of the disclosed systems and methods may allow for the creation of digital assets on a creator platform and for creators who have agreed to a contract to list digital assets on an NFT marketplace. This may prevent anyone other than the copyright owner from posting or otherwise distributing a pirated copy. Viewing rights of digital assets may be protected with DRM during primary and secondary distribution of digital assets on the NFT marketplace. This may ensure the rarity of the digital asset as a legitimate work and may protect the value of the digital asset.

In some embodiments, when creators list their digital assets on the NFT marketplace, the NFT marketplace may also inherit the profit distribution agreed between the copyright holders, so that the profits generated in the primary and secondary distribution respect copyrights. Profits may be divided among rights holders. In addition, transactions on the NFT marketplace may be stored in a form that can be accessed and audited by creators and managed transparently.

Content Item Creation and NFT Minting

Various embodiments of the disclosed systems and methods may provide mechanisms for the creation of content within a creator platform where unique content items may be associated with NFTs and/or other managed unique identifiers. Although various embodiments and examples described herein may reference audio and/or song content for the purposes of illustration and explanation with songwriters as content creators, it will be appreciated that the disclosed systems and methods are not so limited. Indeed, embodiments of the disclosed systems and methods may be used in connection with a variety of types of content and/or data including, for example and without limitation, audio content, video content, text content, multimedia content, software, data (which may comprise proprietary data and/or databases), and/or any other content type.

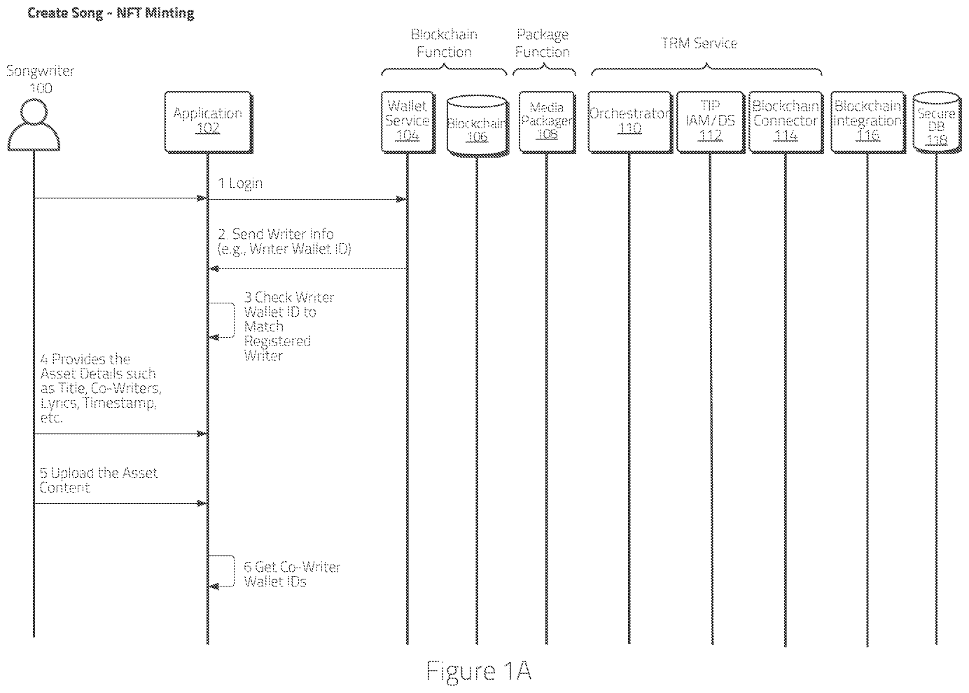

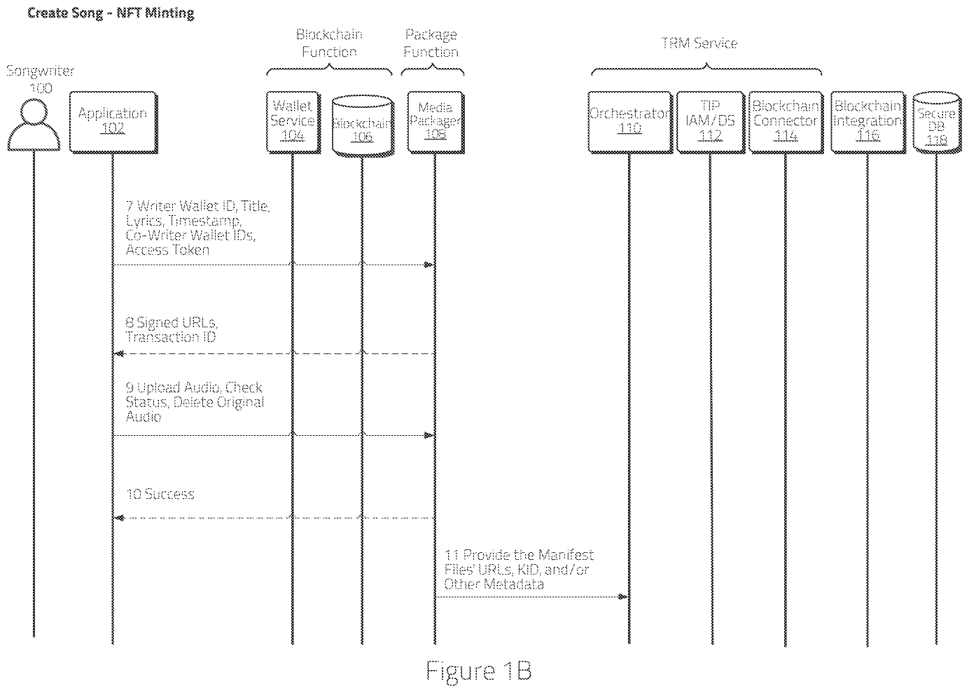

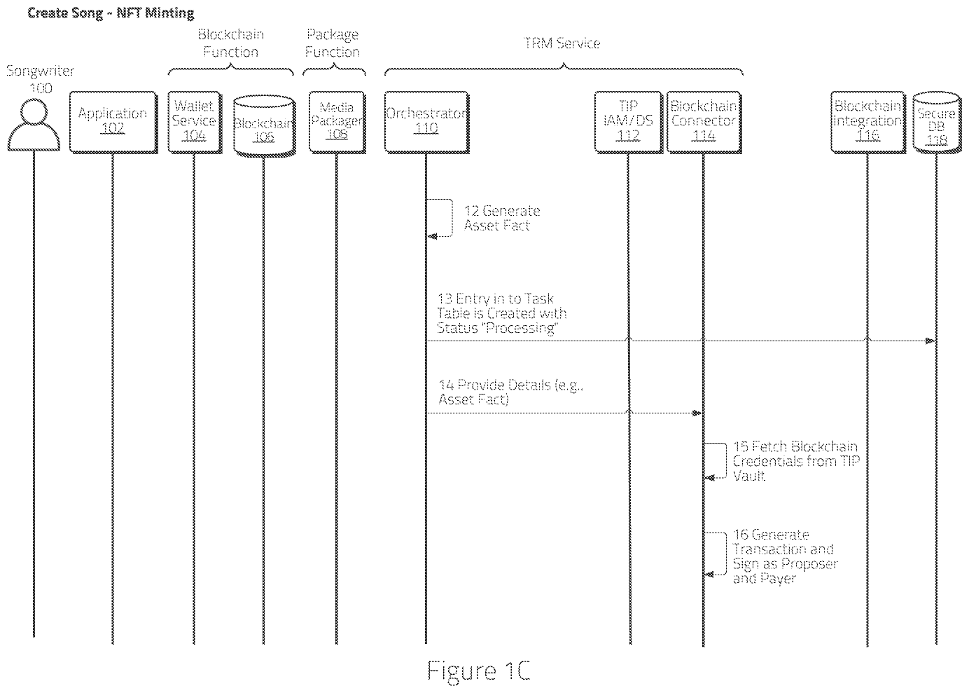

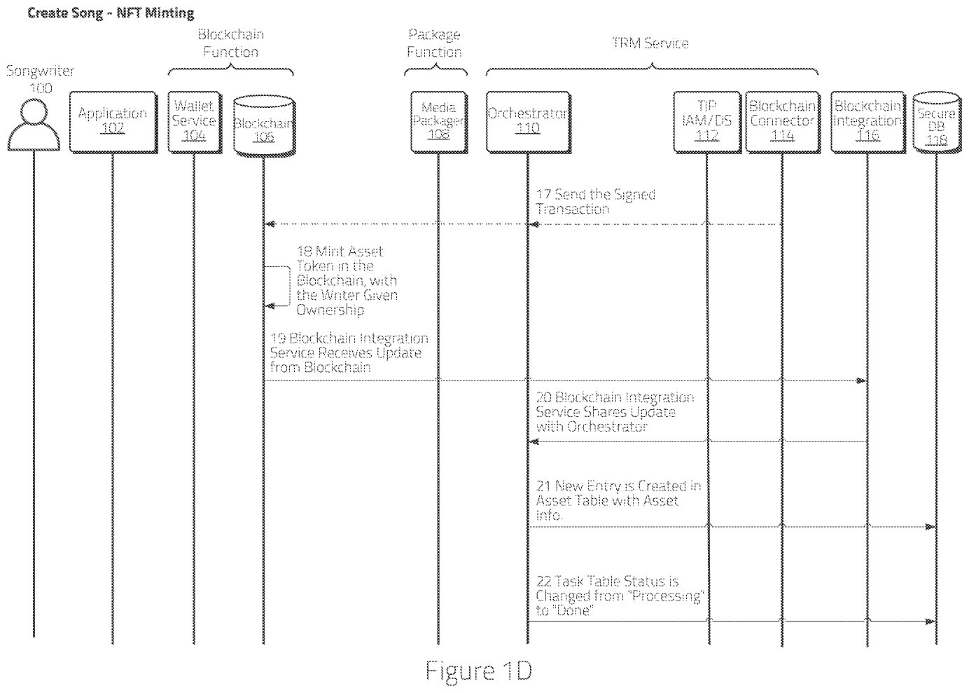

FIGS. 1A-1D illustrate a non-limiting example of a process for creating a song asset in connection with a token management service consistent with certain embodiments disclosed herein. As illustrated, at Step 1, a songwriter 100, which may be a lyrical songwriter and/or a compositional songwriter, may login to an application 102 and/or a wallet service 104 (which may be part of a blockchain function service). Although various embodiments and examples disclosed herein describe a songwriter 102 and/or writer as an entity for purposes of illustration and explanation (and similarly, a consumer, user, and/or editor), it will be appreciated that in various implementations, the songwriter 102 and/or other entities may represent systems and/or devices used to interact with embodiments of the disclosed ecosystem by such entities.

The application 102 may comprise a creator platform and/or marketplace application allowing the songwriter 100 to interact with a creator and/or content management platform consistent with various aspects disclosed herein. The application 102 may comprise an application executing on a user's (e.g., songwriter 100) device and/or computer system, and/or may comprise a remotely accessed service application such as a web application and/or the like. In certain embodiments, a Google account (e.g., Open ID connect) may be used for login, although other methods of login may also be employed.

Upon successful login, at Step 2, writer information associated with the songwriter 100 may be communicated from the wallet service 104 to the application 102. For example and without limitation, in various embodiments, a writer wallet ID may be communicated from the wallet service 104 to the application 102 upon successful login. The writer information may be checked by the application 102 to determine whether the songwriter 100 is registered with the application 102 and/or associated service at Step 3. For example, the application 102 may check whether the writer wallet ID matches that of a registered writer.

At Step 4, the songwriter 100 may provide asset details relating to content to the application 102. For example and without limitation, the songwriter 100 may provide asset details including a content title, co-writers, lyrics, timestamp information, and/or the like. The songwriter 100 may upload the associated asset content to the application 102 at Step 5. If co-writers are specified by the songwriter 100, at Step 6 the application 102 may retrieve co-writer wallet ID information.

The application 102 may send the writer wallet ID, lyrics, timestamp information, co-writer wallet ID information, and/or an associated access token to a media packager service 108 of package functionality of the disclosed ecosystem at Step 7. At Step 8, signed URLs for uploading the content along with associated transaction ID information may be returned to the application 102 from the media packager service 108. The application 102 may, at Step 9, upload the audio content (e.g., the song), check upload status, and/or potentially delete the original audio stored by the application 102 if an indication that the upload was successful is received at Step 10.

The media packager service 108 may provide manifest file URLs associated with the uploaded content, content ID information, a key ID (“KID”), and/or other metadata to an orchestrator service 110 at Step 11. The KID may be generated as a key identifier for a KMS. In various embodiments, the KID may comprise an identifier for a unique key used to encrypt an asset.

The orchestrator service 110 may be part of a TRM service that may further include a TIP identity access management (“IAM”) and/or data service (′DS″) service 112 and/or a blockchain connector service 114. The TIP IAM and/or DS 112 may provide certain governance among various services, systems, and/or entities of the disclosed ecosystem. The blockchain connector service 114 may facilitate integration of various systems and/or services using established commercial blockchain and/or digital wallet services. In various embodiments, the blockchain connector service 114 may provide known APIs and/or other interfaces to allow for relatively seamless interaction between various systems and/or services using other blockchain and/or digital wallet services, allowing for more flexible integration of various embodiments with other blockchain and wallet services. For example and without limitation, in various embodiments, the blockchain connector service 114 may integrate various aspects of the disclosed systems and methods with the FLOW blockchain, although other suitable blockchain services (e.g., Polygon) may also be used in connection with certain disclosed embodiments. Moreover, it will be appreciated that in certain embodiments and examples described herein, various systems and/or services may interact directly with blockchain and/or wallet services without the use of a blockchain connector service 114, potentially interacting with blockchain and/or wallet services (which may be either integrated and/or third-party services) directly (e.g., via native API calls) and/or via other intermediate services.

At Step 12, the orchestrator service 110 may generate an asset fact associated with the uploaded content. A task entry may be created by the orchestrator 110 in a task table maintained by a secure database (“DB”) service 118 with status “processing” at Step 13 while the NFT minting task process for the uploaded content asset takes place. The secure DB service 118 may, among other functionality, manage one or more tables in connection with managing NFTs and/or other aspects of the disclosed systems and methods.

The orchestrator service 110 may provide the blockchain connector service 114 with certain details relating to the minting of an NFT associated with the content asset at Step 14. For example, in some embodiments, the orchestrator service 110 may provide the blockchain connector service 114 with the asset fact information generated at Step 12.

At Step 15, blockchain credentials (e.g., a private key and/or the like) may be retrieved by the blockchain connection service 114 from a TIP vault, which may comprise a TIP service for securely storing protected and/or otherwise secure data. A transaction may be generated by the blockchain connector service 114 at Step 16. In some embodiments, the transaction may be signed with the private key and/or other blockchain credentials retrieved from the TIP vault as proposer and payer.

The blockchain connector service 114 may send the signed transaction to the blockchain 106 at Step 17, potentially via the orchestrator service 110. For example, in some embodiments, the blockchain connector service 114 may call a mintNFT function in a smart contract at the FLOW blockchain by providing the signed transaction. The blockchain 106 may mint the asset token in the blockchain at Step 18, assigning ownership of the token to the songwriter 100.

The blockchain 106 may update a blockchain integration service 116 at Step 19 regarding the minted asset token. In various embodiments, the blockchain integration service 116 may provide various application programming interface (“API”) and/or other interfaces that may allow other systems and/or services to interact with the blockchain 106. In certain implementations, Graffle may be used as a blockchain integration service 116, although other suitable services are also contemplated.

At Step 20, the blockchain integration service 116 may share the update with the orchestrator service 110. The orchestrator service 110 may generate a new entry in an asset table maintained by the secure DB service 118 at Step 21. At Step 22, the task table maintained by the secure DB service 118 by the orchestrator service 110 may be updated with status “done,” “complete,” and/or the like.

Content Item Updating and Updated NFT Minting

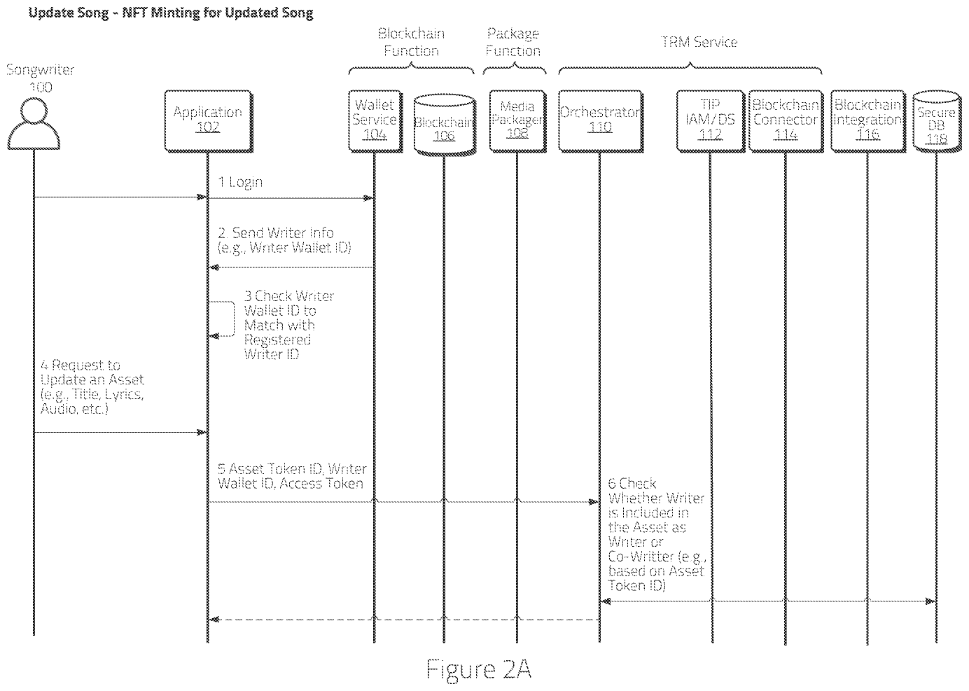

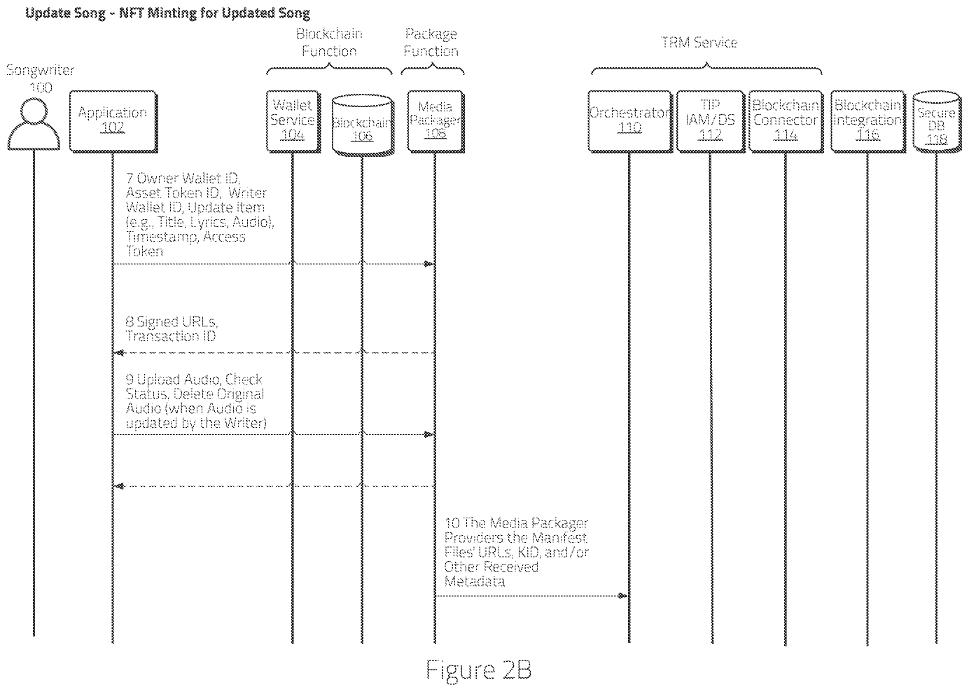

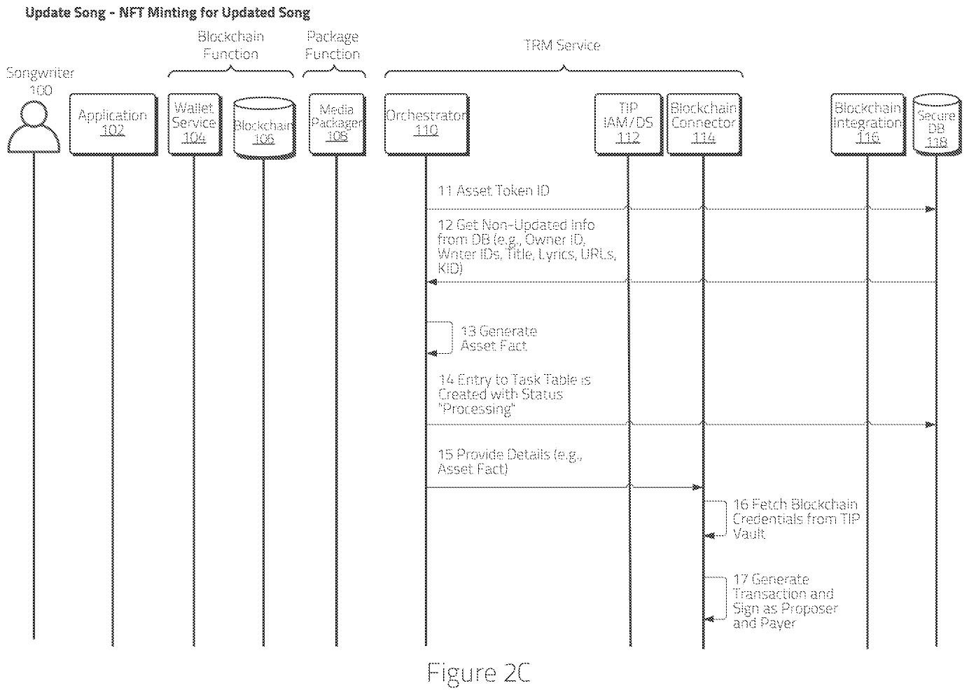

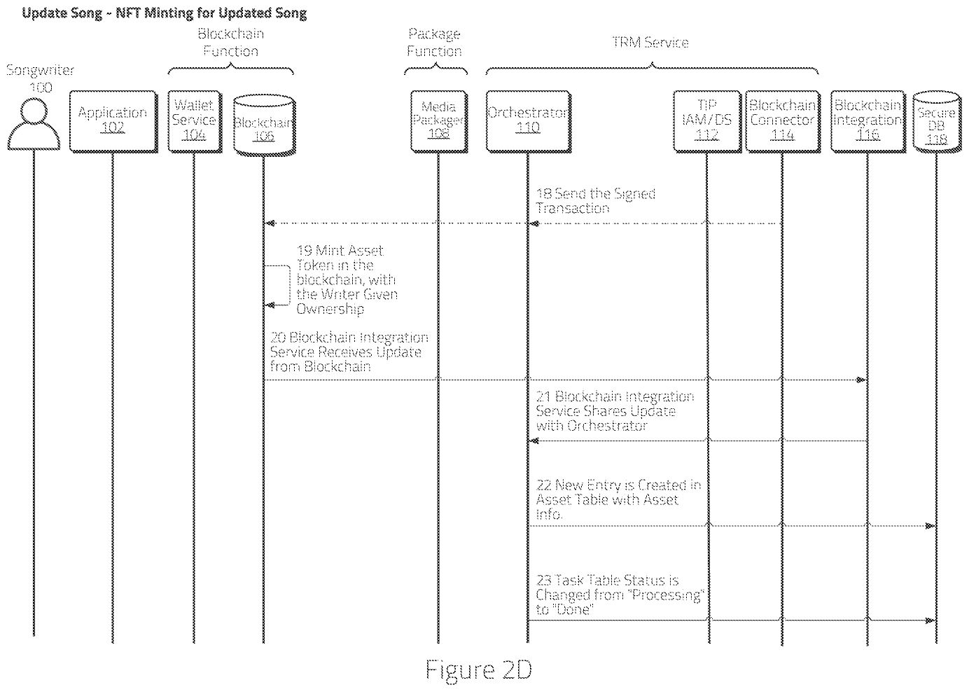

In various embodiments, a content creator may update a content asset and/or information associated with the same within the disclosed ecosystem, which may result in the minting of updated tokens associated with the asset within a blockchain and/or other trusted ledger. FIGS. 2A-2D illustrates a non-limiting example of a process for updating a song in connection with a token management service consistent with certain embodiments disclosed herein.

As illustrated, at Step 1, a songwriter 100 may login to the application 102 and/or a wallet service 104 (which may be part of a blockchain function service). In certain embodiments, a Google account (e.g., Open ID connect) may be used for login, although other methods of login may also be employed. Upon successful login, at Step 2, writer information associated with the songwriter 100 may be communicated from the wallet service 104 to the application 102. For example and without limitation, in various embodiments, a writer wallet ID may be communicated from the wallet service 104 to the application 102 upon successful login. The writer information may be checked by the application 102 to determine whether the songwriter 100 is registered with the application 102 and/or associated service at Step 3. For example, the application 102 may check whether the writer wallet ID matches that of a registered writer.

The songwriter 100 may issue a request to the application 102 at Step 4 to update an asset (e.g., an uploaded audio track) and/or information associated with the same (e.g., title, lyrics, etc.). At Step 5, the application 102 may transmit the corresponding asset token ID information, the writer wallet ID information, and an associated access token to the orchestrator service 110. The orchestrator service 110 may interact with the secure DB service 118 at Step 6 to check whether the requesting songwriter 110 is included in information maintained by the secure DB service 118 relating to the asset (e.g., an asset table and/or the like). For example, the orchestrator service 110 may interact with the secure DB service 118 to determine whether the writer wallet ID is included in an asset table maintained by the secure DB service 118 as a writer or co-writer associated with a particular asset identified based on the asset token ID information. The orchestrator 110 may, in certain embodiments, share the information returned from the secure DB service 118 with the application 102.

The application 102 may send owner wallet ID information associated with an asset, the asset token ID information, the writer wallet ID information, update information (e.g., updated title, lyrics, audio, etc.), timestamp information, and/or the access token to a media packager service 108 of package functionality of the disclosed ecosystem at Step 7. At Step 8, signed URLs for uploading the content along with associated transaction ID information may be returned to the application 102 from the media packager service 108.

At Step 9, the application 102 may upload the updated audio content if the subject of the update is a content update, check upload status, and/or potentially delete the original audio stored by the application 102 if an indication that the upload was successful. In some embodiments, the media packager service 108 may return an indication of the upload and/or other operations performed at Step 9.

The media packager service 108 may provide manifest file URLs associated with the uploaded content, a key ID (“KID”), and/or other metadata to the orchestrator service 110 at Step 10. The orchestrator service 110 may provide the asset token ID to the secure DB service 118 and receive from the secure DB service 118 the original information associated with the asset (e.g., non-updated information) which may include, for example and without limitation, owner ID information, writer ID information, title information, lyrics, URLs, and/or the KID.

At Step 13, the orchestrator service 110 may generate an asset fact associated with the updated content. A task entry may be created by the orchestrator service 110 in the task table maintained by the secure DB service with status “processing” at Step 14. The orchestrator service 110 may provide the blockchain connector service 114 with certain details relating to the minting of an NFT associated with the updated asset at Step 15. For example, in some embodiments, the orchestrator service 110 may provide the blockchain connector service 114 with the asset fact information generated at Step 13.

At Step 16, blockchain credentials (e.g., a private key and/or the like) may be retrieved by the blockchain connector service 114 from the TIP vault. A transaction may be generated by the blockchain connector service 114 at Step 17. In some embodiments, the transaction may be signed with the private key and/or other blockchain credentials retrieved from the TIP vault as proposer and payer.

The blockchain connector service 114 may send the signed transaction to the blockchain 106 at Step 18, potentially via the orchestrator service 110. For example, in some embodiments, the blockchain connector service 114 may call a mintNFT function in a smart contract at the FLOW blockchain by providing the signed transaction. The blockchain 106 may mint the asset token in the blockchain at Step 19, assigning ownership of the token to the songwriter 100.

The blockchain 106 may update a blockchain integration service 116 at Step 20 regarding the minted updated asset token. At Step 21, the blockchain integration service 116 may share the update with the orchestrator service 110. The orchestrator service 110 may generate a new entry in an asset table maintained by the secure DB service 118 at Step 22. At Step 23, the task table maintained by the secure DB service 118 by the orchestrator service 110 may be updated with status “done,” “complete,” and/or the like.

Adding and/or Removing Co-Writer

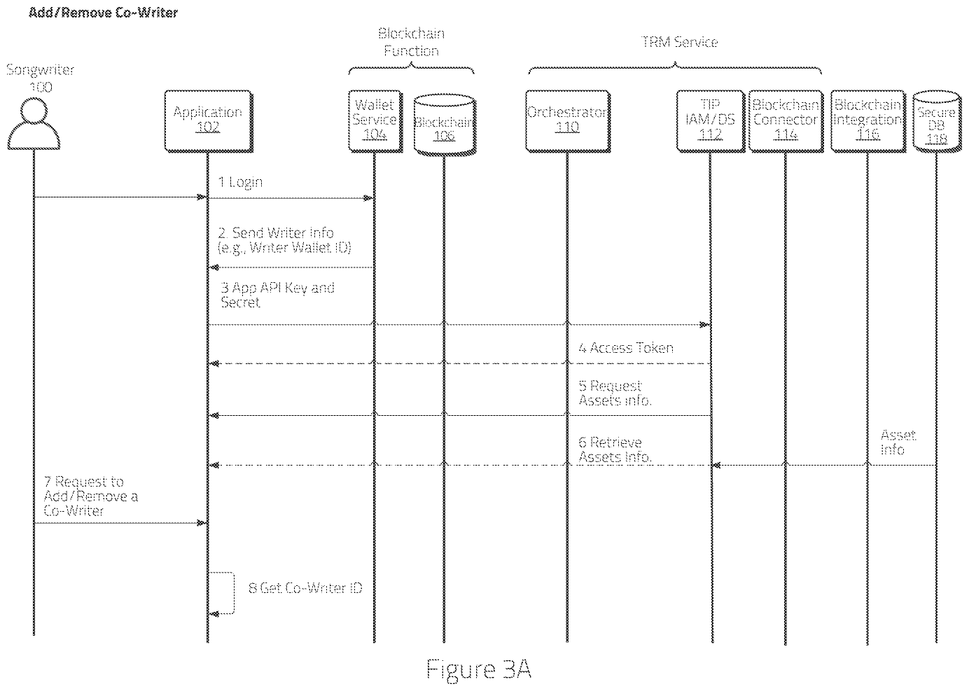

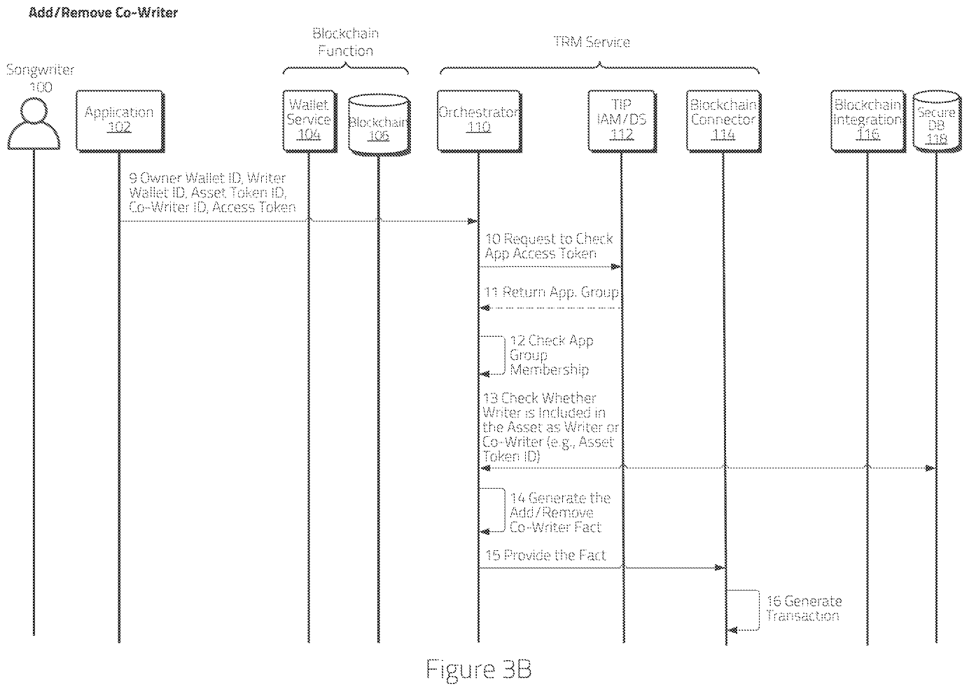

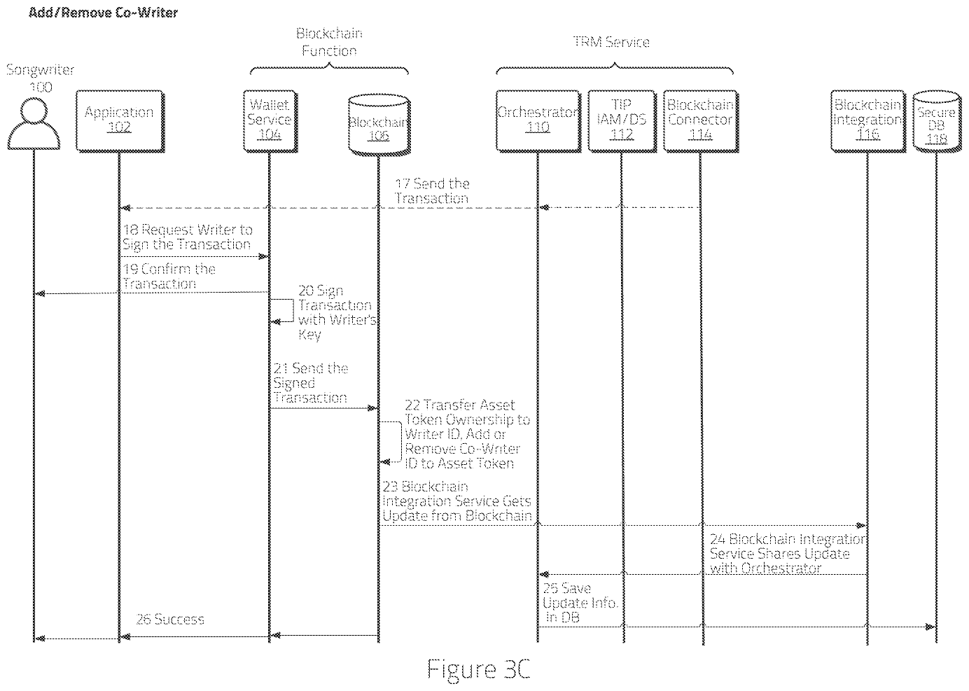

In various embodiments, creators may add and/or remove co-creators from content assets and/or information associated with the same within the disclosed ecosystem. For example and without limitation, in some implementations, a songwriter may add co-writers to content assets managed using various embodiments of the disclosed systems and methods. FIGS. 3A-3C illustrate a non-limiting example of a process for adding and/or removing a co-writer in connection with a token management service consistent with certain embodiments disclosed herein.

At Step 1, a songwriter 100 may login to the application 102 and/or a wallet service 104 (which may be part of a blockchain function service). In certain embodiments, a Google account (e.g., Open ID connect) may be used for login, although other methods of login may also be employed. Upon successful login, at Step 2, writer information associated with the songwriter 100 may be communicated from the wallet service 104 to the application 102. For example and without limitation, in various embodiments, a writer wallet ID may be communicated from the wallet service 104 to the application 102 upon successful login.

The application 102 may communicate an API key and/or secret information to the TIP IAM/DS service 112 in connection with an IAM check process at Step 3. In certain embodiments, the API key and/or secret information may be created by a TRM service administrator and issued to applications for use in connection with obtaining access tokens to authenticate various TRM API calls. The TIP IAM/DS service 112 may at Step 4, upon successful authentication of the API key and/or secret information, issue an access token to the application 102.

At Step 5, the application 102 and/or TIP IAM/DS 112 may request information relating to assets managed by the service associated with the songwriter 100 and/or an associated owner. Asset information may be retrieved from the secure DB service 118 and provided to the application 102 by the TIP IAM/DS service 112 at Step 6.

The songwriter 100 may issue a request to the application 102 to add and/or remove a co-writer to records associated with a content asset at Step 7. The application 102 may, at Step 8, retrieve the co-writer ID. The application 102 may send owner wallet ID information associated with an asset, the asset token ID information, the writer wallet ID information, co-writer ID information, and/or the access token to the orchestrator service 110 at Step 9. Based on the received information, the orchestrator service 110 may check and/or otherwise authenticate the access token with the TIP IAM/DS service 112 at Step 10 and, if authenticated, the TIP IAM/DS service 112 may return group membership information associated with the provided access token to the orchestrator service 110 at Step 11.

At Step 12, the orchestrator service 110 may check the group membership of the application 102. The orchestrator service 110 may interact with the secure DB service 118 at Step 13 to determine whether the writer is included in asset information associated with the asset as a writer and/or co-writer based, at least in part, on the asset token ID information. The orchestrator service 110 at Step 14 may generate a new fact detailing the addition and/or removal of the co-writer and provide the generated fact to the blockchain connector service at Step 15.

A corresponding transaction may be generated by the blockchain connector service 114 at Step 16. At Step 17, the blockchain connector service 114 may return the generated transaction to the orchestrator service 110 which may coordinate sending the transaction to the application 102. The application 102 may issue a request to the wallet service 104 of the blockchain function for the writer to sign the transaction at Step 18. In some embodiments, at Step 19, the wallet service 104 may interact with the songwriter 100 to confirm the transaction. If confirmed, the transaction may be signed by the wallet service 104 using the writer's key at Step 20.

At Step 21, the signed transaction may be sent from the wallet service to the blockchain 106. The blockchain 106 may record an entry transferring the asset token ownership to being associated with the writer ID information, and co-writer ID information may be added or removed (depending on the circumstances) to associations with the asset token at Step 22. The blockchain 106 may provide an update at Step 23 to the blockchain integration service 116 regarding the transfer of the asset token ownership and/or the adding and/or removal of a co-writer. At Step 24, the update may be shared by the blockchain integration service 116 with the orchestrator service 110, which may save the update information in an associated table maintained by the secure DB service 118 at Step 25. The blockchain 106 may communicate an indication of the successful transfer of the asset token ownership and/or the adding and/or removal of a co-writer to the wallet service 104, application 102, and/or songwriter 100 at Step 26.

Inviting/Disinviting a Friend

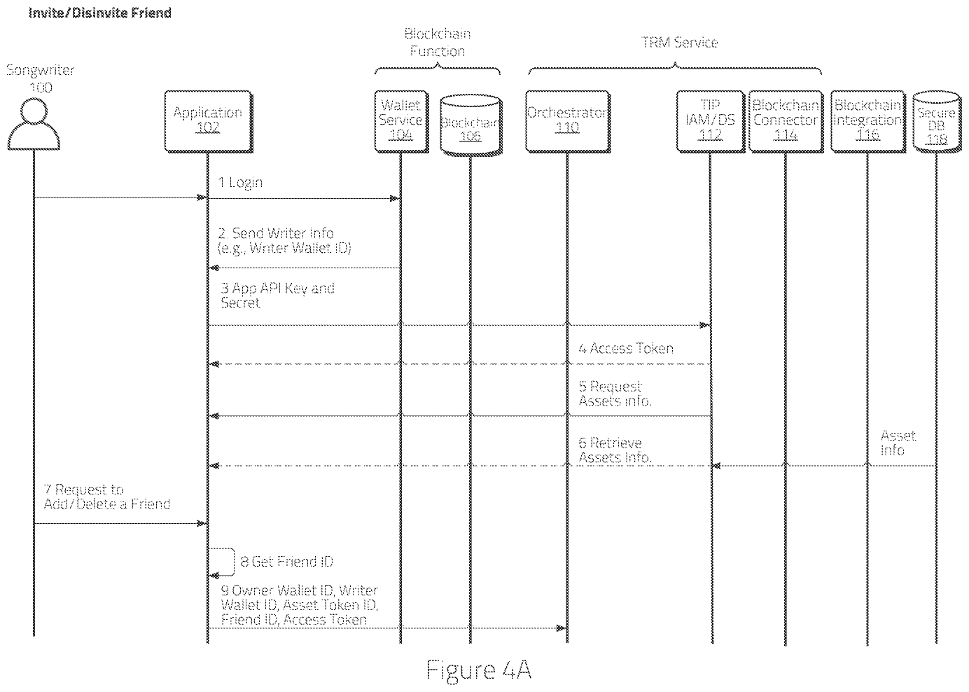

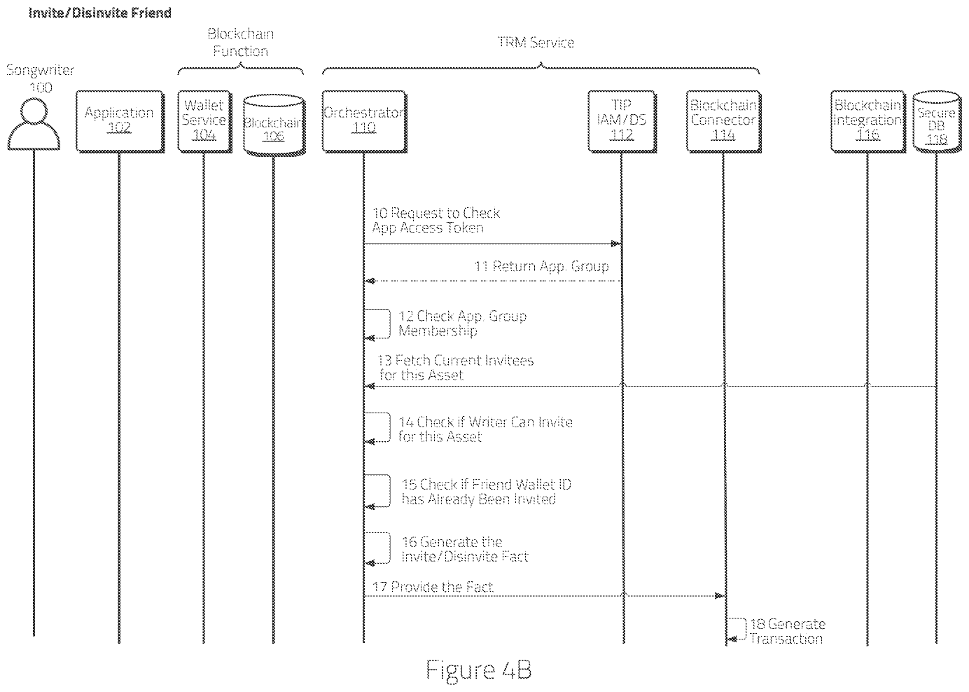

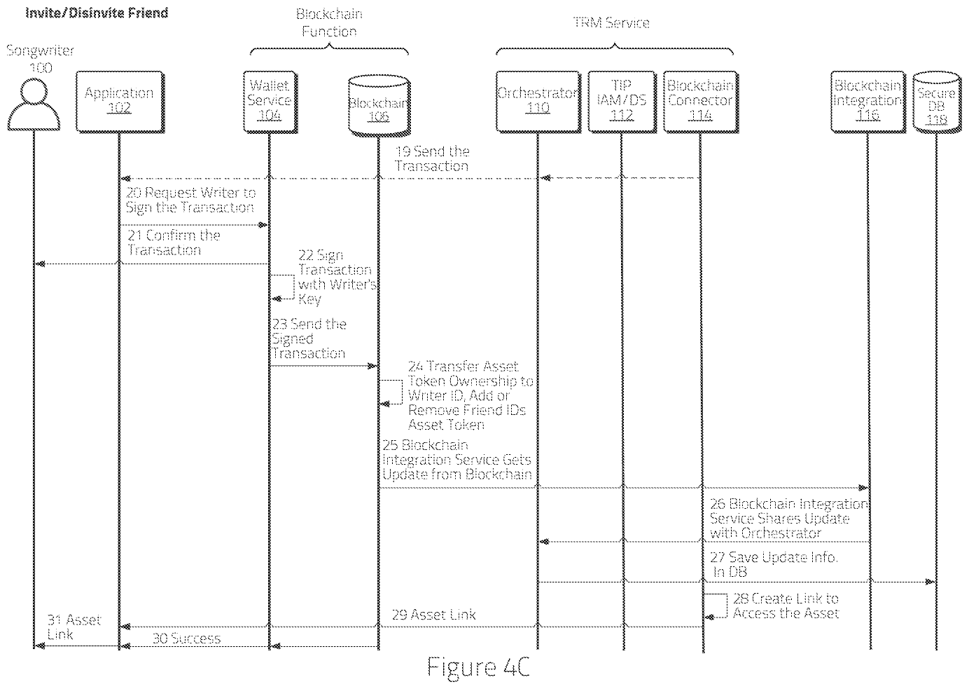

Consistent with embodiments disclosed herein, creators may have their digital assets viewed by stakeholders (e.g., colleagues) and receive feedback. For example and without limitation, in some embodiments, a creator may select a title to be viewed by a friend and then may select the friend to allow for viewing of the title. A person (e.g., a colleague) who has shared digital assets may be shown via an appropriate interface where a user can select and view a title shared with them via an appropriate menu. FIGS. 4A-4C illustrate a non-limiting example of a process for inviting and/or disinviting a friend, colleague, and/or other interested stakeholder (which may be generally referred to herein for purposes of explanation and simplicity as a “friend”) to a song in connection with a token management service consistent with certain embodiments disclosed herein.

At Step 1, a songwriter 100 may login to the application 102 and/or a wallet service 104 (which may be part of a blockchain function service). In certain embodiments, a Google account (e.g., Open ID connect) may be used for login, although other methods of login may also be employed. Upon successful login, at Step 2, writer information associated with the songwriter 100 may be communicated from the wallet service 104 to the application 102. For example and without limitation, in various embodiments, a writer wallet ID may be communicated from the wallet service 104 to the application 102 upon successful login.

The application 102 may communicate an API key and/or secret information to the TIP IAM/DS service 112 in connection with an IAM check process at Step 3. In certain embodiments, the API key and/or secret information may be created by a TRM service administrator and issued to applications for use in connection with obtaining access tokens to authenticate various TRM API calls. The TIP IAM/DS service 112 may at Step 4, upon successful authentication of the API key and/or secret information, issue an access token to the application 102.

At Step 5, the application 102 and/or TIP IAM/DS 112 may request information relating to assets managed by the service associated with the songwriter 100 and/or an associated owner. Asset information may be retrieved from the secure DB service 118 and provided to the application 102 by the TIP IAM/DS service 112 at Step 6.

The songwriter 100 may issue a request to the application 102 to add and/or remove a friend from records associated with a content asset at Step 7. The application 102 may, at Step 8, retrieve ID information associated with the friend. The application 102 may send owner wallet ID information associated with an asset, the asset token ID information, the writer wallet ID information, friend ID information, and/or the access token to the orchestrator service 110 at Step 9. Based on the received information, the orchestrator service 110 may check and/or otherwise authenticate the access token with the TIP IAM/DS service 112 at Step 10 and, if authenticated, the TIP IAM/DS service 112 may return group membership information associated with the provided access token to the orchestrator service 110 at Step 11.

At Step 12, the orchestrator service 110 may check the group membership of the application 102. The orchestrator service 110 may retrieve from the secure DB service 118 at Step 13 any current friends/invitees associated with the asset. At Step 14, the orchestrator service 110 may check if the writer has permissions to invite friends and/or invitees to the asset. In certain embodiments, the orchestrator service may check at Step 15 if the received friend ID information has previously been invited to the asset.

Depending on the outcome of the checks at Step 14 and Step 15, the orchestrator service 110 may generate a new fact at Step 16 detailing the invitation/disinvitation of the friend/invitee and provide the generated fact to the blockchain connector service 114 at Step 17. A corresponding transaction may be generated by the blockchain connector service 114 at Step 18.

At Step 19, the blockchain connector service 114 may return the generated transaction to the orchestrator service 110 which may coordinate sending the transaction to the application 102. The application 102 may issue a request to the wallet service 104 of the blockchain function for the writer to sign the transaction at Step 20. In some embodiments, at Step 21, the wallet service 104 may interact with the songwriter 100 to confirm the transaction. If confirmed, the transaction may be signed by the wallet service 104 using the writer's key at Step 22.

At Step 23, the signed transaction may be sent from the wallet service 104 to the blockchain 106. The blockchain 106 may record an entry transferring the asset token ownership to being associated with the writer ID information, and friend ID information may be added or removed (depending on the circumstances) to associations with the asset token at Step 24.

In certain implementations, including certain illustrated non-limiting examples herein, established blockchain services may allow for a single owner to be associated with an asset token recorded in a blockchain. Consistent with embodiments disclosed herein, multiple entities (e.g., co-writers and/or the like) may have ownership rights in an access token. To facilitate this shared ownership paradigm in connection with certain blockchain services, as detailed in the illustrated non-limiting examples, asset token ownership as recorded in the blockchain 106 may be transferred among multiple co-writers and/or other parties with ownership rights, so that other co-writers and/or owners can invite a friend and/or perform other actions in connection with an asset token requiring ownership rights in the asset token.

It will be appreciated, however, that other implementations may facilitate recordation of ownership rights of multiple entities (e.g., fractional ownership rights) to an access token by a blockchain service, limiting the need to transfer asset token ownership recorded in the blockchain 106 to multiple co-writers and/or other parties with ownership rights. Moreover, further non-limiting examples and embodiments may allow for different rights to attach to different owners and/or other entities via recorded blockchain entries. For example and without limitation, certain entities may have ownership rights, with a subset thereof having rights to invite friends to use and/or otherwise interact with an asset, initiate signing of contracts and/or other agreements relating to an asset, and/or the like. In this manner, rights and/or other permissioned uses that may attached to an asset via recordation in a blockchain service consistent with embodiments disclosed herein may be flexible and extensible, allowing integration of the disclosed systems and methods within in a variety of implementations and/or circumstances.

The blockchain 106 may provide an update at Step 25 to the blockchain integration service 116 regarding the transfer of the asset token ownership and/or the adding and/or removal of a friend. At Step 26, the update may be shared by the blockchain integration service 116 with the orchestrator service 110, which may save the update information in an associated table maintained by the secure DB service 118 at Step 27.

The blockchain connector service 114 may generate a link to the asset at Step 28, communicating the asset link to the application 102 at Step 29. In some embodiments, the blockchain 106 may communicate an indication of the successful transfer of the asset token ownership and/or the adding and/or removal of a friend to the wallet service 104, application 102, and/or songwriter 100 at Step 30. The application 102 may provide the songwriter the asset link received from the blockchain connector service 114 at Step 31.

Playback

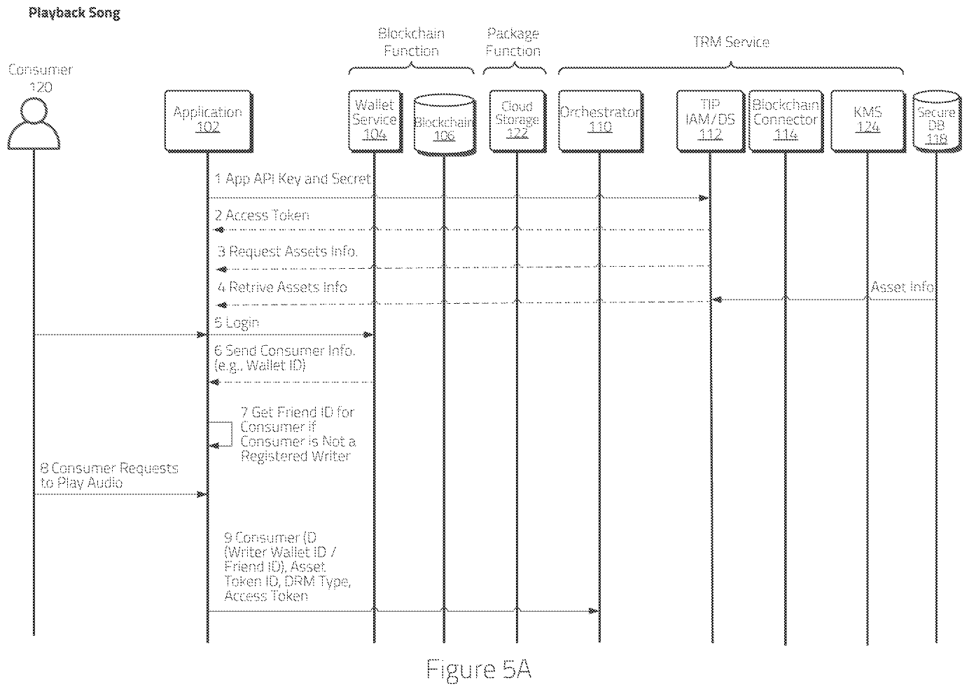

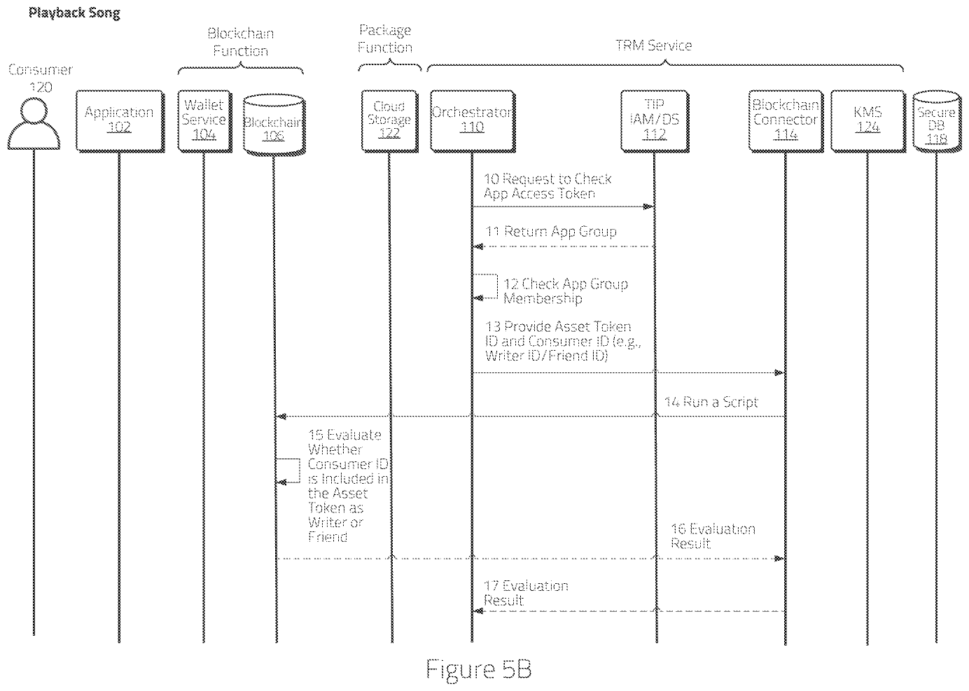

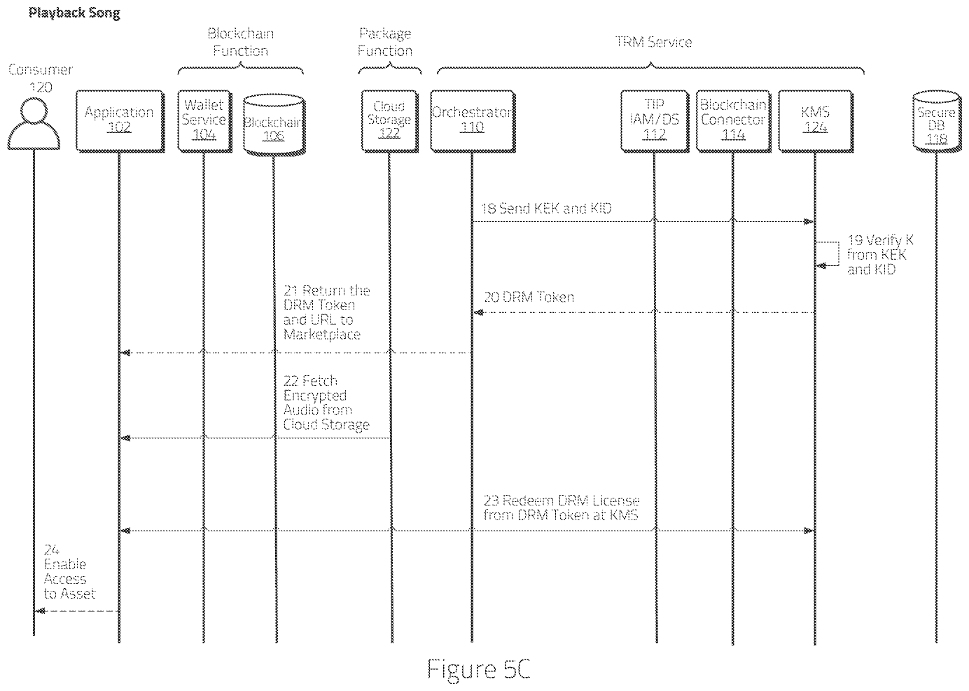

Consistent with embodiments disclosed herein, content asset playback and/or rendering may be managed using various aspects of the disclosed systems and methods. FIGS. 5A-5C illustrate a non-limiting example of a process for playing back a song in connection with a token management service consistent with certain embodiments disclosed herein.

The application 102 may communicate an API key and/or secret information to the TIP IAM/DS service 112 in connection with an IAM check process at Step 1. In certain embodiments, the API key and/or secret information may be created by a TRM service administrator and issued to applications for use in connection with obtaining access tokens to authenticate various TRM API calls. The TIP IAM/DS service 112 may at Step 2, upon successful authentication of the API key and/or secret information, issue an access token to the application 102.

At Step 3, the application 102 and/or TIP IAM/DS 112 may request information relating to assets managed by the ecosystem. Asset information may be retrieved from the secure DB service 118 and provided to the application 102 by the TIP IAM/DS service 112 at Step 4.

A content consumer 120 may login to the application 102 and/or a wallet service 104 at Step 5. The wallet service 104 may send the application 102 information associated with the consumer 120 based on information provided in the login process at Step 6. For example and without limitation, the wallet service 104 may send wallet ID information associated with the consumer 120 to the application 102 based on received login information. Using the received consumer information, the application 102 may retrieve friend ID information for the consumer 120 at Step 7 if the consumer was not registered previously as a writer and/or co-writer of an asset.

At Step 8, the consumer 120 may issue a request to play audio content to the application 102. In response, the application 102 may forward to the orchestrator service 110 the consumer ID information (which may comprise writer wallet ID information, friend wallet ID information, and/or the like), asset token ID information, a type of requested DRM access, the access token issued to the application, and/or the like at Step 9. Based on the received information, the orchestrator service 110 may check and/or otherwise authenticate the access token with the TIP IAM/DS service 112 at Step 10 and, if authenticated, the TIP IAM/DS service 112 may return group membership information associated with the provided access token to the orchestrator service 110 at Step 11.

At Step 12, the orchestrator service 110 may check the group membership of the application 102. The orchestrator service 110 may provide the asset token ID and/or the consumer ID information (e.g., writer ID and/or friend ID information) to the blockchain connector service 114 at Step 13. The blockchain connector service 114 may run a script in connection with a blockchain 106 interaction at Step 14 to evaluate whether the consumer ID is included in and/or otherwise associated with the asset token as a writer and/or friend. The blockchain 106 may perform the evaluation at Step 15, returning the result to the blockchain connector service 114 at Step 16, which may share it with the orchestrator service 110 at Step 17.

The orchestrator service 110 may transmit a key encryption key (“KEK”) and a KID to a KMS 124 at Step 18. In various embodiments, the KID may be used as a key identifier for the KMS 124. At Step 19, the KMS may use the KEK and KID to verify a content key—K—used to protect an associated digital content asset. If the K is verified, the KMS 124 may issue and transmit a DRM token to the orchestrator service 110 at Step 20.

At Step 21, the orchestrator service 110 may return the DRM token and a URL and/or other link to the digital content to the application 102. The application 102 may retrieve the encrypted content (e.g., using the link information) from a cloud storage service 122 of the package function at Step 22. At step 23, the application 102 may interact with the KMS 124 to redeem a DRM license using the DRM token, and then use the redeemed DRM license to enable the consumer 120 to access the content.

Create Contract

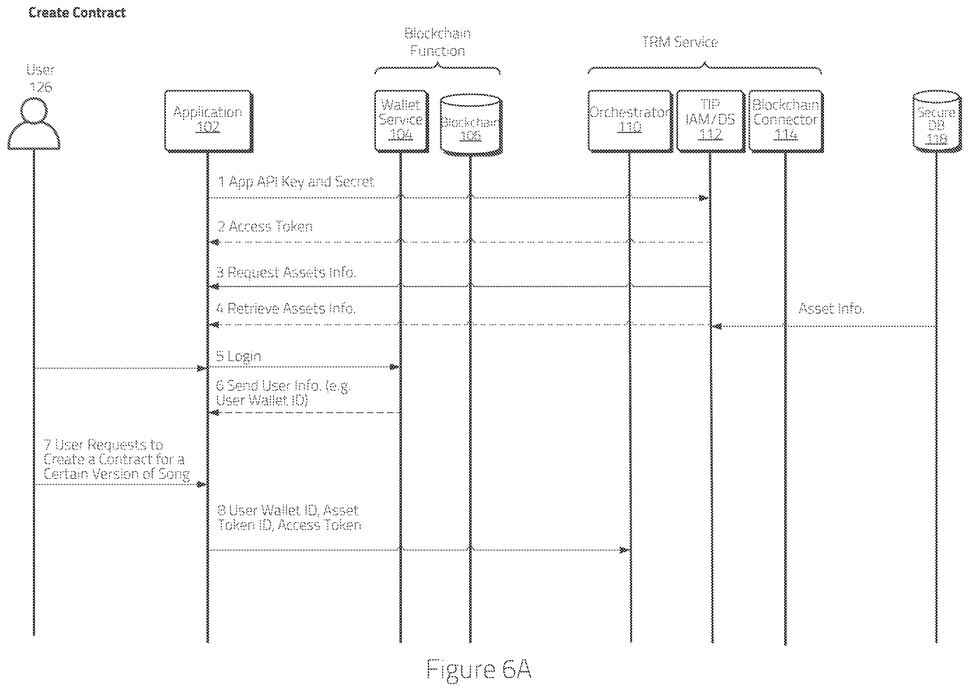

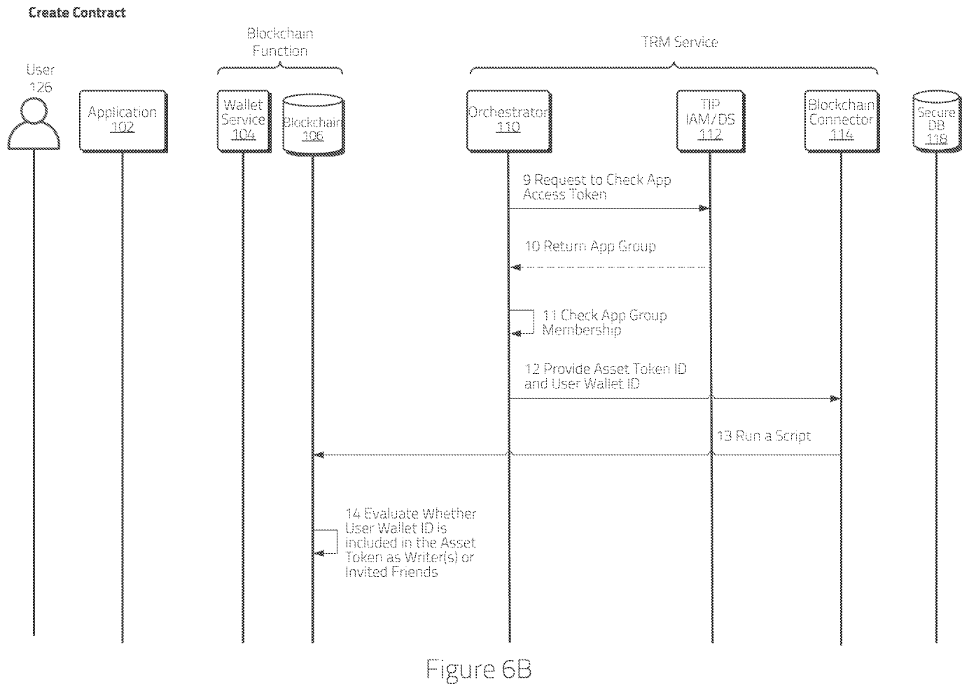

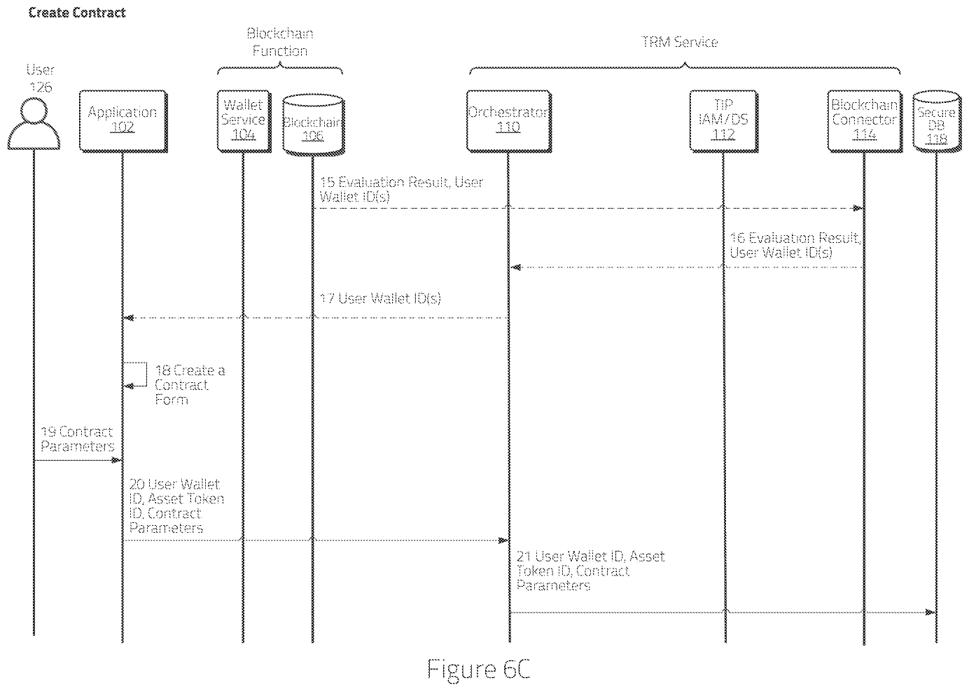

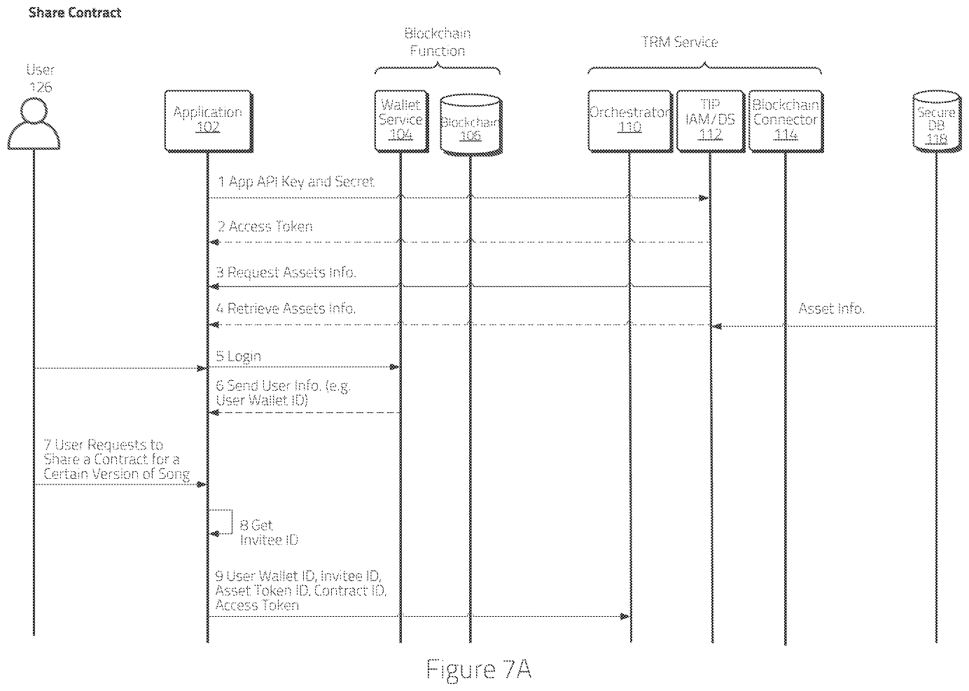

Consistent with various disclosed embodiments, various users (e.g., songwriters, co-writers, and/or the like) may create contracts and/or other enforceable agreements relating to digital assets. Such contracts may, for example and without limitation, delineate enforceable terms relating to profit sharing among the co-authors who created the digital asset. FIGS. 6A-6C illustrates a non-limiting example of a process for creating a contract in connection with a token management service consistent with certain embodiments disclosed herein.

As illustrated, at Step 1, the application 102 may communicate an API key and/or secret information to the TIP IAM/DS service 112 in connection with an IAM check process. In certain embodiments, the API key and/or secret information may be created by a TRM service administrator and issued to applications for use in connection with obtaining access tokens to authenticate various TRM API calls. The TIP IAM/DS service 112 may at Step 2, upon successful authentication of the API key and/or secret information, issue an access token to the application 102.

At Step 3, the application 102 and/or TIP IAM/DS 112 may request information relating to assets managed by the ecosystem. Asset information may be retrieved from the secure DB service 118 and provided to the application 102 by the TIP IAM/DS service 112 at Step 4. A user 126 may login to the application 102 and/or a wallet service 104 at Step 5. The wallet service 104 may send the application 102 information associated with the user 126 based on information provided in the login process at Step 6. For example and without limitation, the wallet service 104 may send wallet ID information associated with the user 126 to the application 102 based on received login information.

At Step 7, the user 126 may issue a request to the application 102 create a contract associated with a certain version of a digital asset (e.g., a song and/or the like). In response, at Step 8 the application 102 may forward to the orchestrator service 110 the user ID information (which may comprise user wallet ID information), asset token ID information, the access token issued to the application 102, and/or the like. Based on the received information, the orchestrator service 110 may check and/or otherwise authenticate the access token with the TIP IAM/DS service 112 at Step 9 and, if authenticated, the TIP IAM/DS service 112 may return group membership information associated with the provided access token to the orchestrator service 110 at Step 10.

At Step 11, the orchestrator service 110 may check the group membership of the application 102. The orchestrator service 110 may provide the asset token ID and/or the user ID information (e.g., user wallet ID information) to the blockchain connector service 114 at Step 12. The blockchain connector service 114 may run a script in connection with a blockchain 106 interaction at Step 13 to evaluate whether the user wallet ID information is included in and/or otherwise associated with the asset token as a writer and/or invited friend. The blockchain 106 may perform the evaluation at Step 14, returning the result along with the user wallet ID information to the blockchain connector service 114 at Step 15, which may share it with the orchestrator service 110 at Step 16.

The orchestrator service 110 may communicate the user wallet ID information to the application 102 at Step 17. Based, at least in part, on the received information, the application 102 may create a contract form at Step 18. At Step 19, the user 126 may share contract parameters with the application 102. The application 102 may communicate the user wallet ID, asset token ID, and/or contract parameters to the orchestrator service 110 at Step 20, which may forward them to the secure DB service 118 for storage at Step 21.

Share Contract

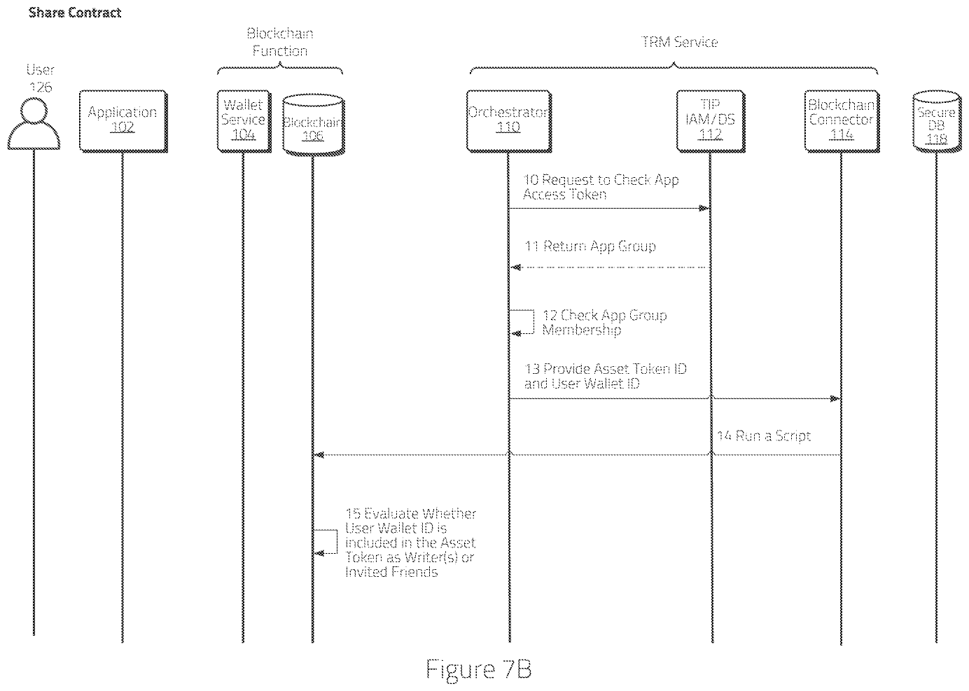

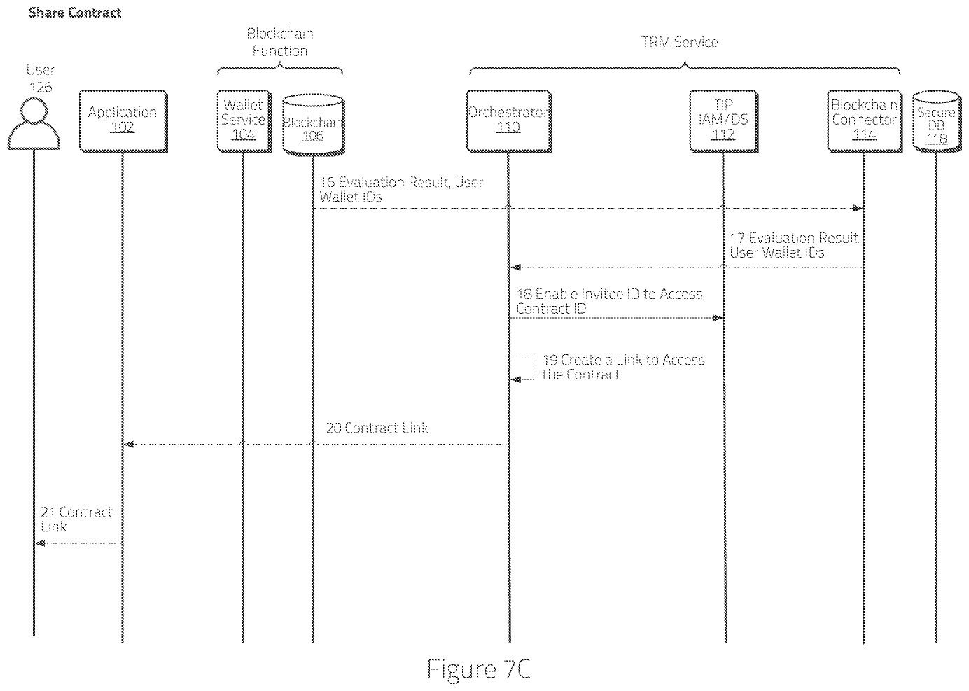

Embodiments of the disclosed systems and methods may further facilitate sharing of generated contracts between parties. FIGS. 7A-7C illustrate a non-limiting example of a process for sharing a contract in connection with a token management service consistent with certain embodiments disclosed herein.

As illustrated, at Step 1, the application 102 may communicate an API key and/or secret information to the TIP IAM/DS service 112 in connection with an IAM check process. In certain embodiments, the API key and/or secret information may be created by a TRM service administrator and issued to applications for use in connection with obtaining access tokens to authenticate various TRM API calls. The TIP IAM/DS service 112 may at Step 2, upon successful authentication of the API key and/or secret information, issue an access token to the application 102.

At Step 3, the application 102 and/or TIP IAM/DS 112 may request information relating to assets managed by the ecosystem. Asset information may be retrieved from the secure DB service 118 and provided to the application 102 by the TIP IAM/DS service 112 at Step 4. A user 126 may login to the application 102 and/or a wallet service 104 at Step 5. The wallet service 104 may send the application 102 information associated with the user 126 provided in the login process at Step 6. For example and without limitation, the wallet service 104 may send wallet ID information associated with the user 126 to the application 102 based on received login information.

At Step 7, the user 126 may issue a request to the application 102 to share a contract associated with a certain version of a digital asset (e.g., a song and/or the like). In response, at Step 8 the application 102 may retrieve the ID information associated with the invitee that is the subject of the user's request. The application 102 may forward to the orchestrator service 110 the user ID information (which may comprise user wallet ID information), invitee ID information, asset token ID information, the access token issued to the application 102, and/or the like at Step 9.

Based on the received information, the orchestrator service 110 may check and/or otherwise authenticate the access token with the TIP IAM/DS service 112 at Step 10 and, if authenticated, the TIP IAM/DS service 112 may return group membership information associated with the provided access token to the orchestrator service 110 at Step 11.

At Step 12, the orchestrator service 110 may check the group membership of the application 102. The orchestrator service 110 may provide the asset token ID and/or the user ID information (e.g., user wallet ID information) to the blockchain connector service 114 at Step 13. The blockchain connector service 114 may run a script in connection with a blockchain 106 interaction at Step 14 to evaluate whether the user wallet ID information is included in and/or otherwise associated with the asset token as a writer and/or invited friend. The blockchain 106 may perform the evaluation at Step 15, returning the result along with the user wallet ID information to the blockchain connector service 114 at Step 16, which may share it with the orchestrator service 110 at Step 17.

The orchestrator service 110 may coordinate with the TIP IAM/DS 112 to enable the invitee ID to access the contract ID at Step 18. At Step 19, the orchestrator service may create a link for accessing the contract (e.g., a URL). The contract link may be shared with the application 102 at Step 20, which may provide the link to the user 126 at Step 21.

Edit Contract

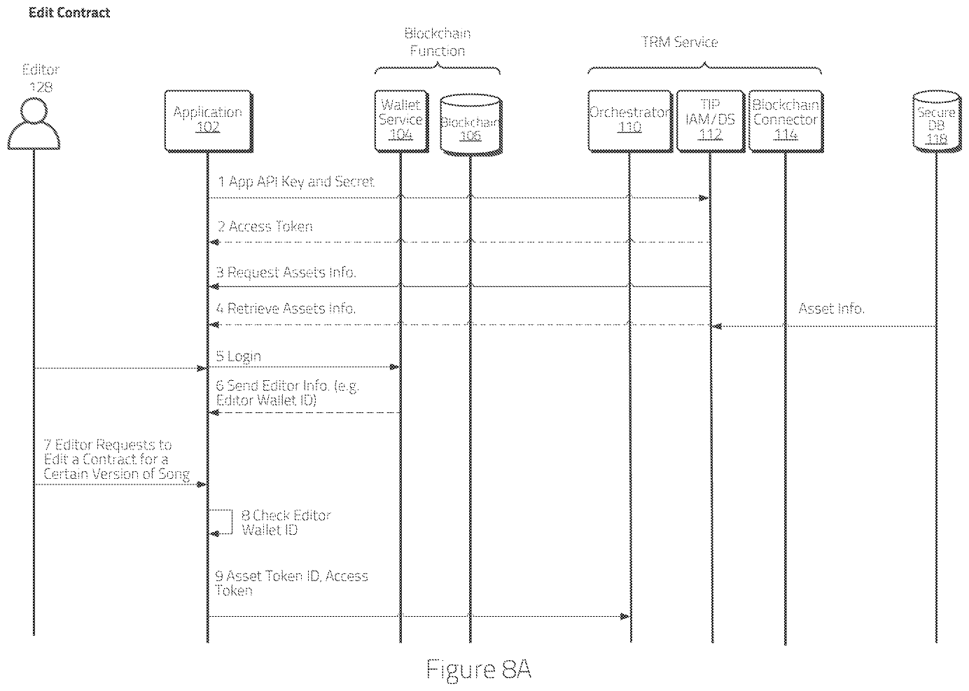

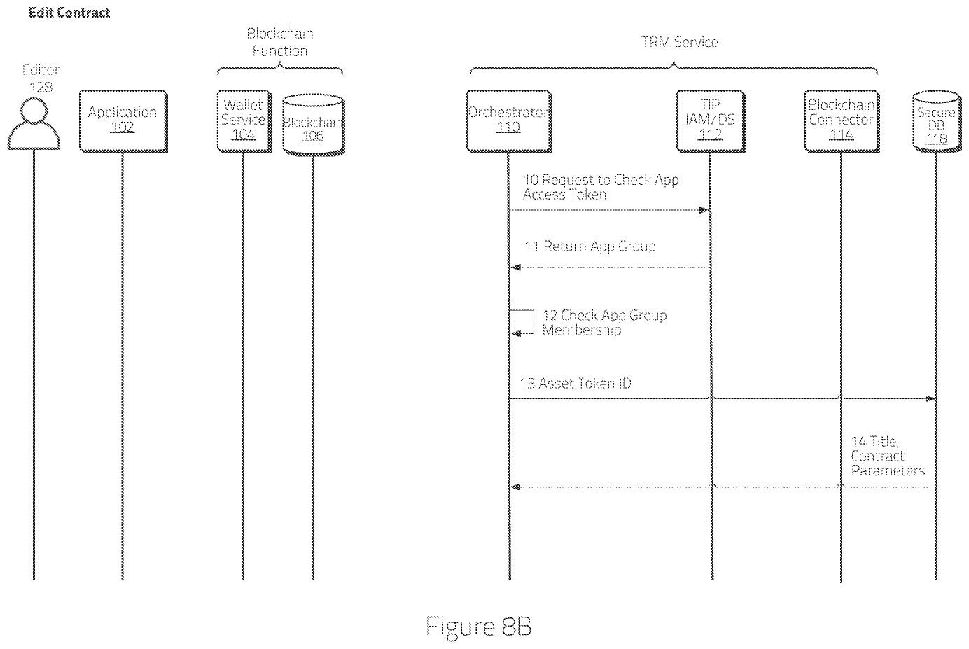

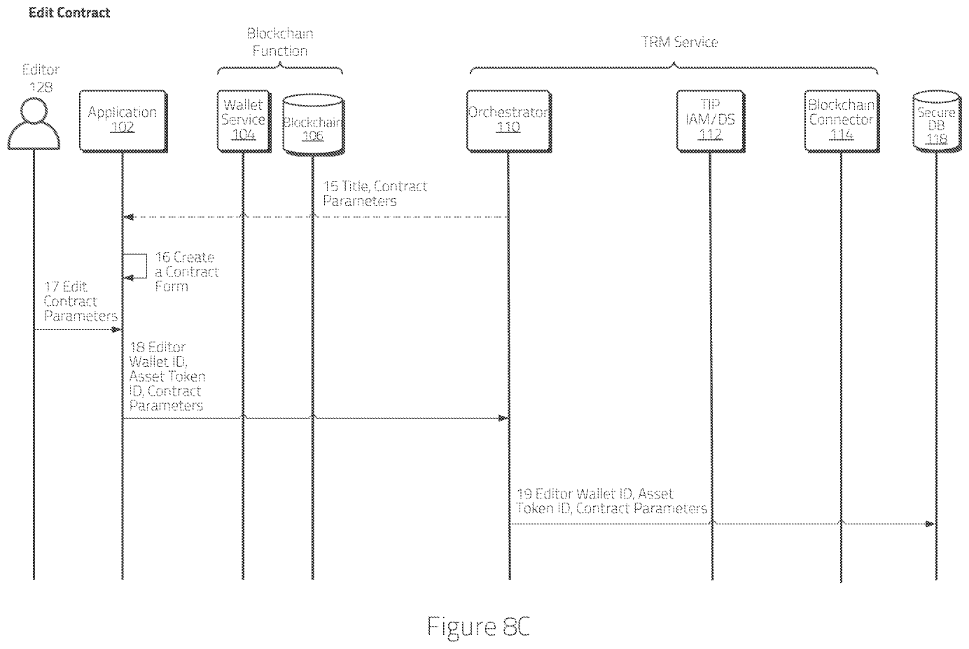

After creation of a contract, embodiments disclosed herein may allow for various parties (in some embodiments, parties and/or entities with sufficient permissions) to edit a contract. FIGS. 8A-8C illustrate a process for editing a contract in connection with a token management service consistent with certain embodiments disclosed herein.

As illustrated, at Step 1, the application 102 may communicate an API key and/or secret information to the TIP IAM/DS service 112 in connection with an IAM check process. In certain embodiments, the API key and/or secret information may be created by a TRM service administrator and issued to applications for use in connection with obtaining access tokens to authenticate various TRM API calls. The TIP IAM/DS service 112 may at Step 2, upon successful authentication of the API key and/or secret information, issue an access token to the application 102.

At Step 3, the application 102 and/or TIP IAM/DS 112 may request information relating to assets managed by the ecosystem. Asset information may be retrieved from the secure DB service 118 and provided to the application 102 by the TIP IAM/DS service 112 at Step 4. An editor 128 may login to the application 102 and/or a wallet service 104 at Step 5. The wallet service 104 may send the application 102 information associated with the editor 128 based on information provided in the login process at Step 6. For example and without limitation, the wallet service 104 may send wallet ID information associated with the editor 128 to the application 102 based on received login information.

At Step 7, the editor 128 may issue a request to the application 102 edit a contract associated with a certain version of a digital asset (e.g., a song and/or the like). In response, at Step 8 the application 102 may check the editor ID to determine whether to proceed with the process allowing editing of the contract. The application 102 may forward to the orchestrator service 110 the asset token ID information, the access token issued to the application 102, and/or the like at Step 9.

Based on the received information, the orchestrator service 110 may check and/or otherwise authenticate the access token with the TIP IAM/DS service 112 at Step 10 and, if authenticated, the TIP IAM/DS service 112 may return group membership information associated with the provided access token to the orchestrator service 110 at Step 11. At Step 12, the orchestrator service 110 may check the group membership of the application 102.

The orchestrator service 110 may provide the asset token ID to the secure DB service 118 at Step 13. Based on the received asset token ID, the secure DB service 118 may retrieve at Step 14 corresponding title information and/or associated contract parameters for the digital asset and forward the information to the orchestrator service 110. The orchestrator service 102 may share the corresponding title information and/or associated contract parameters for the digital asset with the application 102 at Step 15.

At Step 16, the application 102 may create a contract form based on the received information (e.g., the received title and/or contract parameters). The editor 128 may provide the application 102 with any edits to the contractor parameters at Step 17. At Step 18, the application 102 may send the editor wallet ID information, the asset token ID information, and contract parameters, which may comprise received edited contract parameters, to the orchestrator service 110. The orchestrator service 110 may share the editor wallet ID information, the asset token ID information, and contract parameters, including any edited contract parameters, with the secure DB service 118 for storage at Step 19.

Contract Signing

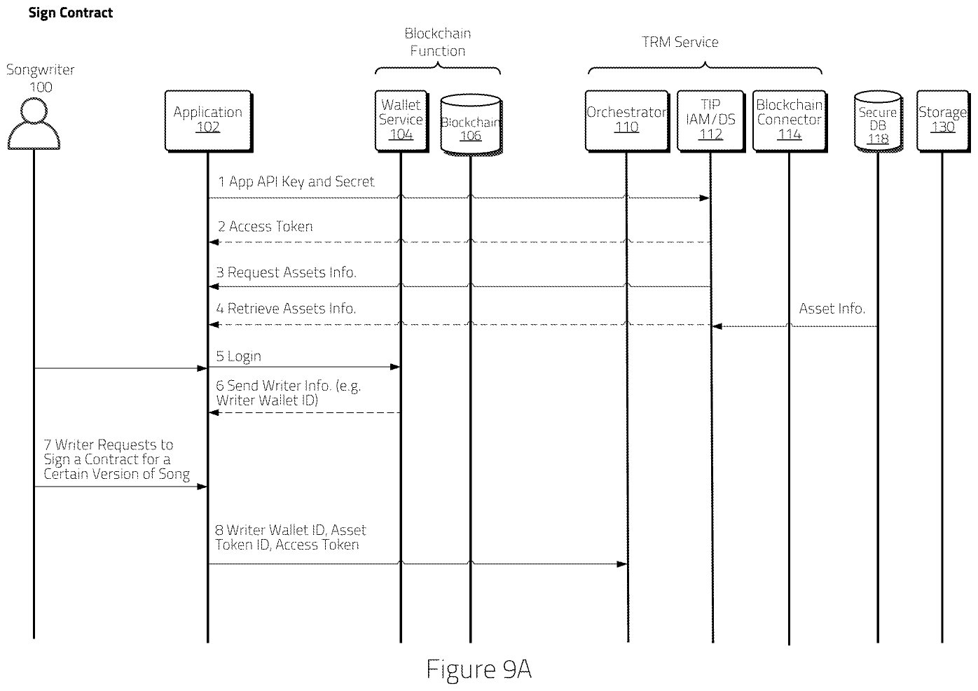

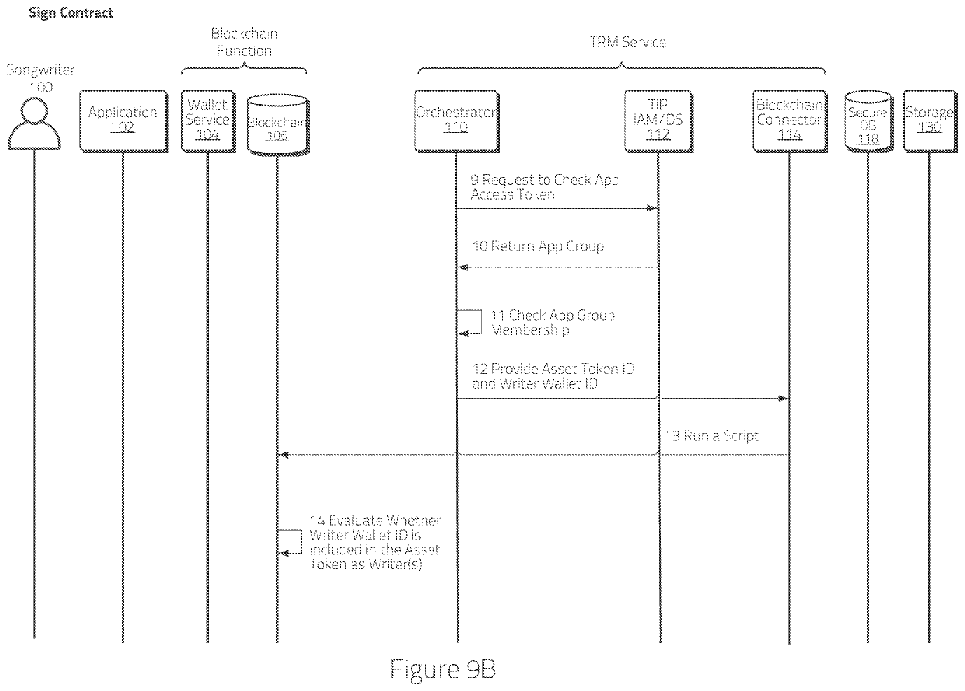

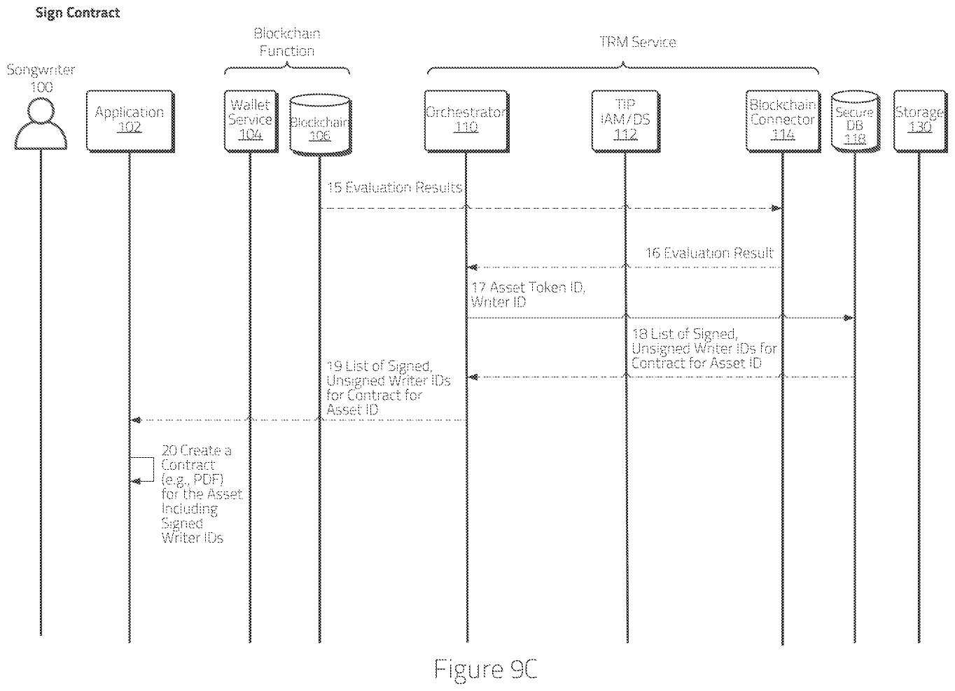

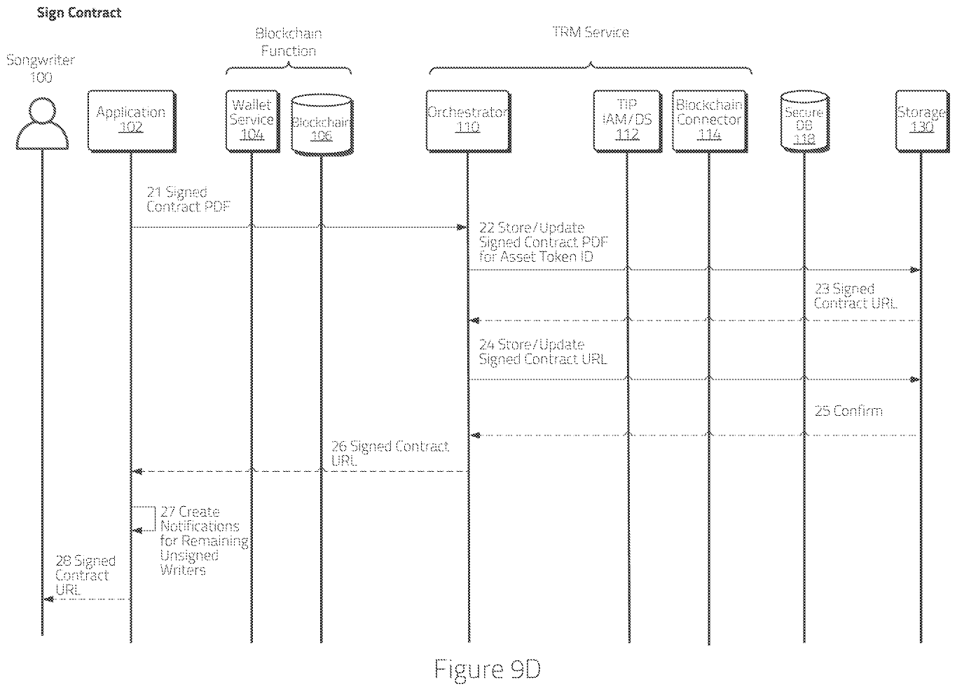

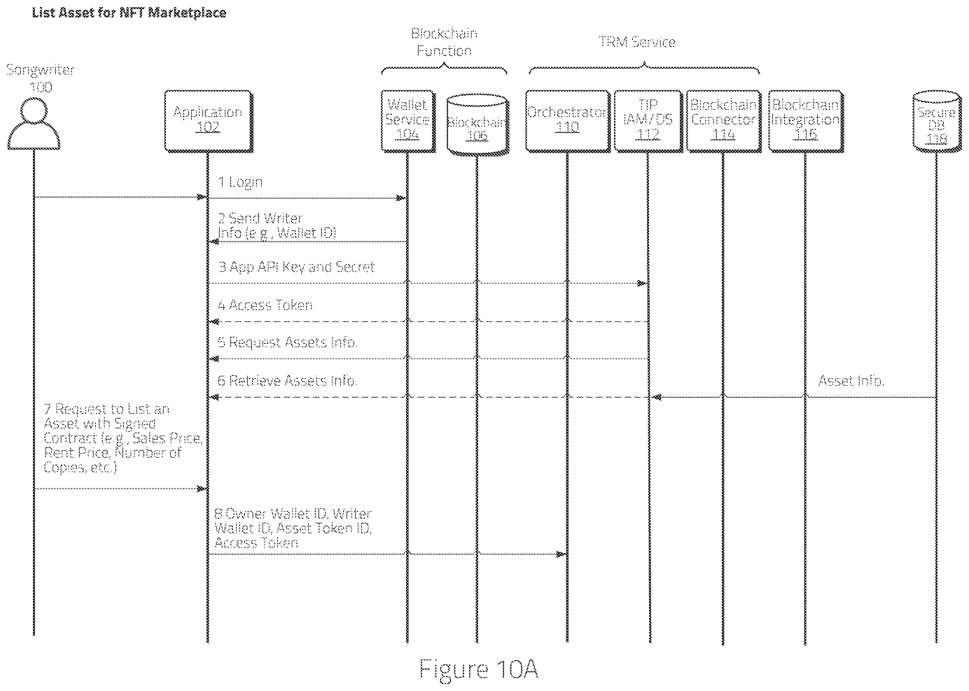

Various embodiments disclosed herein may allow parties to a contract relating to a digital asset to securely sign and/or otherwise execute a contract to evidence agreement to the contract terms. FIGS. 9A-9C illustrate a non-limiting example of a process for signing a contract in connection with a token management service consistent with certain embodiments disclosed herein.

At Step 1, the application 102 may communicate an API key and/or secret information to the TIP IAM/DS service 112 in connection with an IAM check process. In certain embodiments, the API key and/or secret information may be created by a TRM service administrator and issued to applications for use in connection with obtaining access tokens to authenticate various TRM API calls. The TIP IAM/DS service 112 may at Step 2, upon successful authentication of the API key and/or secret information, issue an access token to the application 102.

At Step 3, the application 102 and/or TIP IAM/DS 112 may request information relating to assets managed by the ecosystem. Asset information may be retrieved from the secure DB service 118 and provided to the application 102 by the TIP IAM/DS service 112 at Step 4. A songwriter 100 may login to the application 102 and/or a wallet service 104 at Step 5. The wallet service 104 may send the application 102 information associated with the songwriter 100 based on information provided in the login process at Step 6. For example and without limitation, the wallet service 104 may send wallet ID information associated with the songwriter 100 to the application 102 based on received login information.

At Step 7, the songwriter 100 may issue a request to the application 102 to sign a contract associated with a certain version of a digital asset (e.g., a song and/or the like). In response, the application 102 may retrieve the ID information associated with the songwriter 100. The application 102 may forward to the orchestrator service 110 the songwriter ID information (which may comprise the songwriter wallet ID information), asset token ID information, the access token issued to the application 102, and/or the like at Step 8.

Based on the received information, the orchestrator service 110 may check and/or otherwise authenticate the access token with the TIP IAM/DS service 112 at Step 10 and, if authenticated, the TIP IAM/DS service 112 may return group membership information associated with the provided access token to the orchestrator service 110 at Step 11.

At Step 12, the orchestrator service 110 may check the group membership of the application 102. The orchestrator service 110 may provide the asset token ID and/or the writer ID information (e.g., writer wallet ID information) to the blockchain connector service 114 at Step 13. The blockchain connector service 114 may run a script in connection with a blockchain 106 interaction at Step 14 to evaluate whether the writer wallet ID information is included in and/or otherwise associated with the asset token as a writer and/or invited friend. In certain embodiments, invited friends may have rights to perform certain actions in connection with an asset, which may include permissible uses of the asset (e.g., viewing and/or the like). In further embodiments, an invited friend may have certain other rights attached to an asset and/or may have the ability to perform certain actions relating to the asset. For example and without limitation, an invited friend may have a role as an agent, an attorney, and/or a party to a transaction involving the digital asset (e.g., a contract and/or the like), potentially allowing for the creation and/or signing of contracts by invited friends. Such rights may be inherent with an entity having a recorded status as an invited friend, may be defined as subset of an invited friend, and/or may be separately and/or otherwise explicitly defined. In certain implementations, including the illustrated non-limiting examples, writers and/or invited friends may initiate a contract signing for a certain version of an asset, but only writers may be allowed to (and/or be required to) sign the contract. It will be appreciated, however, that a variety of other implementations are also possible within the scope of the disclosed embodiments.

The blockchain 106 may perform the evaluation at Step 15, returning the result along with the writer wallet ID information to the blockchain connector service 114 at Step 16, which may share it with the orchestrator service 110 at Step 17.

The orchestrator service 110 may coordinate with the TIP IAM/DS 112 to enable the invitee ID to access the contract ID at Step 18. At Step 19, the orchestrator service may create a link for accessing the contract. The contract link may be shared with the application 102 at Step 20, which may provide the link to the songwriter 100 at Step 21.

Based on the received information, the orchestrator service 110 may check and/or otherwise authenticate the access token with the TIP IAM/DS service 112 at Step 9 and, if authenticated, the TIP IAM/DS service 112 may return group membership information associated with the provided access token to the orchestrator service 110 at Step 10. At Step 11, the orchestrator service 110 may check the group membership of the application 102.

The orchestrator service 110 may provide the asset token ID and the songwriter ID information (e.g., the songwriter wallet ID) to the blockchain connector service 114 at Step 12. The blockchain connector service 114 may run a script in connection with a blockchain 106 interaction at Step 13 to evaluate whether the songwriter wallet ID information is included in and/or otherwise associated with the asset token as a writer. The blockchain 106 may perform the evaluation at Step 14, returning the result along with the songwriter wallet ID information to the blockchain connector service 114 at Step 15, which may share it with the orchestrator service 110 at Step 16.

The orchestrator service 110 may communicate the songwriter ID information (e.g., the songwriter wallet ID) and/or the asset token ID to the secure DB service 118 at Step 17. The secure DB service 118 may return to the orchestrator service 110 at Step 18 a list of signed and/or signed writer ID information for a contract associated with the asset ID information. The list may be shared by the orchestrator service 110 with the application 102 at step 20.

At Step 20, a contract may be created by the application 102 for the asset that may include the signed writer ID information. The contract may be generated in a variety of suitable formats. For example and without limitation, in some embodiments the contract may be generated in a portable document format (“PDF”), although other suitable formats are also contemplated. The signed contract may be provided to the orchestrator service 110 by the application 102 at Step 21.

At Step 22, the orchestrator service may store and/or otherwise update a previously stored contract associated with the asset token ID information in a storage service 130. The storage service 130 may return a link (e.g., a URL) of the signed contracted to the orchestrator service 110 at Step 23. At Step 24, the orchestrator service may store and/or updated the signed contract URL with the storage service 130 may provide the orchestrator service 110 with a confirmation of the storage and/or update at Step 25.

The signed contract link information may be shared with the application 102 by the orchestrator service 110 at Step 26. In various embodiments, the application 102 may generate one or more notifications at Step 27 for any remaining unsigned writers to the contract at Step 26. The notifications may be transmitted to systems, services, and/or devices associated with the unsigned writers. At step 28, the signed contract link may be shared with the songwriter 100 by the application 102.

Based on the received asset token ID and/or user, the secure DB service 118 may retrieve at Step 14 corresponding title information and/or associated contract parameters for the digital asset and forward the information to the orchestrator service 110. The orchestrator service 102 may share the corresponding title information and/or associated contract parameters for the digital asset with the application 102 at Step 15.

Marketplace Service Listing

Embodiments disclosed herein may allow creators of digital assets (e.g., songwriters) to list digital assets that have been agreed upon by co-creators (if any) to an NFT marketplace for distribution. In certain implementations, the creator who is the seller may decide how to sell (e.g., number of sales, viewing rights only, both viewing rights and sales rights, etc.) and/or price. Consistent with embodiments disclosed herein, consumers may purchase available usage rights via primary and/or secondary distribution marketplaces. Transactions in the primary and/or secondary distribution of the NFT marketplace may be recorded on a blockchain and/or other trusted ledger, which may allow creators to trace their content assets. FIGS. 10A-10D illustrate a non-limiting example of a process for listing a content asset in connection with a token management service consistent with certain embodiments disclosed herein.

As illustrated, at Step 1, a songwriter 100 may login to the application 102 and/or a wallet service 104. In certain embodiments, a Google account (e.g., Open ID connect) may be used for login, although other methods of login may also be employed. Upon successful login, at Step 2, writer information associated with the songwriter 100 may be communicated from the wallet service 104 to the application 102. For example and without limitation, in various embodiments, a writer wallet ID may be communicated from the wallet service 104 to the application 102 upon successful login.

The application 102 may communicate an API key and/or secret information to the TIP IAM/DS service 112 in connection with an IAM check process at Step 3. In certain embodiments, the API key and/or secret information may be created by a TRM service administrator and issued to applications for use in connection with obtaining access tokens to authenticate various TRM API calls. The TIP IAM/DS service 112 may at Step 4, upon successful authentication of the API key and/or secret information, issue an access token to the application 102.

At Step 5, the application 102 and/or TIP IAM/DS 112 may request information relating to assets managed by the ecosystem. Asset information may be retrieved from the secure DB service 118 and provided to the application 102 by the TIP IAM/DS service 112 at Step 6.

The songwriter 100 may issue a request to the application 102 to list an asset with a marketplace along with a signed contract at Step 7. The signed contract may include information detailing and/or otherwise relating to various parameters relating to the listing of the asset on the marketplace. These parameters may comprise, for example and without limitation, one or more of a sales price, a rental price, a number of copies available for rent, a number of copies available for sale, various temporal rental and/or sale parameters (e.g., rental duration(s), and/or the like), and/or any other parameter relating to the listing of an asset on the marketplace.

The application 102 may send owner wallet ID information associated with an asset, the asset token ID information, the writer wallet ID information, co-writer ID information (if any), and/or the access token to the orchestrator service 110 at Step 8. Based on the received information, the orchestrator service 110 may check and/or otherwise authenticate the access token with the TIP IAM/DS service 112 at Step 9 and, if authenticated, the TIP IAM/DS service 112 may return group membership information associated with the provided access token to the orchestrator service 110 at Step 10.

At Step 11, the orchestrator service 110 may check the group membership of the application 102. The orchestrator service 110 may interact with the secure DB service 118 at Step 12 to determine whether the writer is included in asset information associated with the asset as a writer and/or co-writer based, at least in part, on the asset token ID information. In addition, the orchestrator service 110 may interact with the secure DB service 118 to determine whether a contract has been signed by all writers and/or co-writers for the asset and exchange relevant contract parameters (e.g., revenue % share parameters and/or the like). At Step 13, orchestrator service 110 at Step 14 may generate a new fact detailing the contract parameters and/or a subset thereof (e.g., revenue % share parameters and/or the like).

The orchestrator service 110 may provide the asset fact to the blockchain connector service 114 at Step 14. The blockchain connector service 114 may retrieve relevant blockchain credential(s) at Step 15, and then generate and/or sign a transaction for recording the asset fact to the blockchain 106 at Step 16 (e.g., using the retrieved blockchain credential and/or information derived from the same). At Step 17, the blockchain connector service 114 may send the transaction to the blockchain 106, potentially via the orchestrator service 110. The blockchain may mint an asset token in the blockchain at step 18, assigning ownership of the token to the songwriter 100. The blockchain 106 may update a blockchain integration service 116 at Step 19 regarding the minted asset token. At Step 20, the blockchain integration service 116 may share the update with the orchestrator service 110.

At Step 21, the orchestrator service 210 may save the update information with the secure DB service 118 (e.g., in an appropriate table and/or the like). The orchestrator service may generate a fact associated with the listing of the asset at Step 22, and provide the generated list fact to the blockchain connector service 114 at Step 23. Based on the list fact, at Step 24, the blockchain connector service 114 may generate a corresponding transaction and send the transaction to the orchestrator service 210, which may share the transaction with the application at Step 25.

The application 102 may issue a request to the wallet service 104 of the blockchain function for the writer to sign the transaction at Step 26. In some embodiments, at Step 27, the wallet service 104 may interact with the songwriter 100 to confirm the transaction. If confirmed, the transaction may be signed by the wallet service 104 using the writer's key at Step 28.

At Step 29, the signed transaction may be sent from the wallet service 104 to the blockchain 106. The blockchain 106 may record an entry transferring the asset token ownership to being associated with the writer ID information, and co-writer ID information may be added or removed (depending on the circumstances) to associations with the asset token at Step 30. The blockchain 106 may provide an update at Step 31 to the blockchain integration service 116 regarding the transfer of the asset token ownership and/or the adding and/or removal of a friend. At Step 32, the update may be shared by the blockchain integration service 116 with the orchestrator service 110, which may save the update information in an associated table maintained by the secure DB service 118 at Step 33. At Step 34, a success message may be generated by the blockchain 106 and shared with the wallet service 104, the application 102, and/or the songwriter 100.

FIG. 11 illustrates a flow chart of a non-limiting example of a method for managing a content asset consistent with certain embodiments of the present disclosure. The illustrated method 1100 may be implemented in a variety of ways, including using software, firmware, hardware, and/or any combination thereof. In certain embodiments, various aspects of the method 1100 and/or its constituent steps may be performed by a service, system, and/or device configured to implement embodiments of a TRM service (and/or associated services such as, for example and without limitation, a orchestrator service, a TIP service, IAM/DS service, blockchain connector service, a KMS service), and/or any other suitable application, device, system and/or service or combination of applications, devices, systems, and/or services.

At 1102, a TRM service may receive from an application associated with a first user (e.g., a content rights management application, which may be associated with a marketplace service and/or the TRM service itself) a first access token, ID information relating to the first user, which in some embodiments may comprise a user wallet ID (e.g., a blockchain service wallet ID), and/or ID information associated with a content asset managed by the TRM service. In certain embodiments, the first access token may be issued by the TRM service and/or an associated service (e.g., a TIP IAM/DS service) in response to validation of information provided to the TRM service by the application (e.g., API key and/or other secret information).

A variety of content assets may be managed in connection with aspects of the disclosed embodiments. For example, consistent with embodiments disclosed herein, the content asset may comprise one or more of audio content, video content, text content, data content, software content, and/or any other suitable type of content and/or combinations of content (e.g., multimedia content).

The TRM service may validate the first access token at 1104. For example, in some embodiments, the TRM service may use a TIP IAM/DS service to validate the access token. If the token is validated, at 1106 a trusted ledger service may be queried by the TRM service using a blockchain connector service to determine whether the ID information relating to the first user and the content asset ID information are securely associated with each other via an entry in the trusted ledger. In certain embodiments, the trusted ledger service may execute on a separate system than the system executing the TRM service. In various embodiments, the trusted ledger may comprise a TIDAL and/or a blockchain ledger, although other suitable types of secure and/or otherwise trusted ledgers are also contemplated.

At 1108, a first indication may be received by the TRM service (e.g., the connector service) from the trusted ledger service. In some embodiments, the first indication may indicate that the ID information associated with the first user is securely associated with the content asset ID information in the trusted ledger. For example, the first indication may indicate that the trusted ledger has previously recorded an assertion securely associated a user wallet ID with the content asset ID.

The token rights management service may receive one or more parameters relating to the use of the content asset from the content rights management application at 1110. Consistent with various embodiments disclosed herein, the one or more parameters may be reflected in a contract associated with the content asset and may comprise at least one parameter relating to one or more of a sale of the content asset, a rental of the content asset, a number of available copies of the content asset, and/or temporal parameters relating to the use, sale, and/or rents of the content asset, although other parameters and/or types of parameters are also contemplated.

At 1112, based on receiving the first indication, the one or more parameters relating to the use of the content asset may be securely associated with at least the first user ID information and the content asset ID by the TRM service. For example, a secure association between at least the first user ID, the content asset ID, and the one or more parameters may be recorded in a secure DB managed by a secure DB service, which may execute on a separate system from the TRM service and/or be implemented by the same system.

Consistent with various embodiments, the TRM service may coordinate the signature and/or execution of an indication of the one or more parameters at 1114 (this is, a contract relating to the content asset that includes the one or more parameters). For example and without limitation, in some embodiments, the TRM service may receive a second access token (which may be the same as the first access token), ID information relating to a second user (which may be the same user and/or a different user invited to sign the contract such as, for example and without limitation, a content creator, co-creator, and/or other rightsholder), and/or ID information associated with the content access. In certain embodiments, the ID information associated with the second user may comprise wallet ID information for the second user.

The TRM service may validate the second access token with the IAM service and, in response to validating the access token, query the trusted ledger service using the connector service to determine whether the second user ID information is securely associated with the content asset ID information in the trusted ledger. A second indication may be received from the trusted ledger service that the second user ID information is securely associated with the content asset ID information in the trusted ledger. Based on receiving the second indication, the TRM system may securely associate the content asset ID information with a signed indication received by the TRM service generated using a cryptographic key associated with the second user.

Example System and/or Service Architecture

FIG. 12 illustrates a non-limiting example of a system 1200 that may be used to implement certain embodiments of the systems and methods of the present disclosure. The system 1200 of FIG. 12 and/or aspects thereof may be included in a system, service, and/or device associated with an songwriter and/or other content creator (e.g., a co-writer), a user, a consumer, and editor, a buyer, a renter, a marketplace service, a TRM service, a TIP service, a TIDAL and/or an associated service, a DRM and/or KMS service, a DB, a file storage service, a blockchain integration service, a wallet service, a blockchain service, a media packager service, cloud storage services, an orchestrator service, a blockchain connector service, and/or any other service, which may comprise a trusted service, system, and/or component configured to implement embodiments of the disclosed systems and methods and/or aspects thereof.

The various systems and/or devices used in connection with aspects the disclosed embodiments may be communicatively coupled using a variety of networks and/or network connections (e.g., network 1212). In certain embodiments, the network 1212 may comprise a variety of network communication devices and/or channels and may utilize any suitable communications protocols and/or standards facilitating communication between the systems and/or devices. The network 1212 may comprise the Internet, a local area network, a virtual private network, and/or any other communication network utilizing one or more electronic communication technologies and/or standards (e.g., Ethernet or the like). In some embodiments, the network 1212 may comprise a wireless carrier system such as a personal communications system (“PCS”), and/or any other suitable communication system incorporating any suitable communication standards and/or protocols. In further embodiments, the network 1212 may comprise an analog mobile communications network and/or a digital mobile communications network utilizing, for example, code division multiple access (“CDMA”), Global System for Mobile Communications or Groupe Special Mobile (“GSM”), frequency division multiple access (“FDMA”), and/or time divisional multiple access (“TDMA”) standards, 4G and/or 5G communication standards (e.g., Long-Term Evolution (“LTE”), 5G New Radio (“NR”), orthogonal frequency division multiple access (“OFDMA”), etc.). In certain embodiments, the network 1212 may incorporate one or more satellite communication links. In yet further embodiments, the network 1212 may utilize IEEE's 802.11 standards, Bluetooth®, ultra-wide band (“UWB”), Zigbee®, and or any other suitable standard or standards.

The various systems and/or devices used in connection with aspects of the disclosed embodiments may comprise a variety of computing devices and/or systems, including any computing system or systems suitable to implement the systems and methods disclosed herein. For example, the connected devices and/or systems may comprise a variety of computing devices and systems, including laptop computer systems, desktop computer systems, server computer systems, distributed computer systems, smartphones, tablet computers, and/or the like.

In certain embodiments, the systems and/or devices may comprise at least one processor system configured to execute instructions stored on an associated non-transitory computer-readable storage medium. As discussed in more detail below, systems used in connection with implementing various aspects of the disclosed embodiments may further comprise a secure processing unit (“SPU”) configured to perform sensitive operations such as trusted credential and/or key management, cryptographic operations, secure policy management, and/or other aspects of the systems and methods disclosed herein. The systems and/or devices may further comprise software and/or hardware configured to enable electronic communication of information between the devices and/or systems via a network using any suitable communication technology and/or standard.

In some embodiments, the system 1200 may, alternatively or in addition, include a trusted execution environment and/or an SPU 1218 that is protected from tampering by a user of the system or other entities by utilizing secure physical and/or virtual security techniques. A trusted execution environment and/or a SPU 1218 can help enhance the security of sensitive operations such as personal information management, trusted credential, token, and/or key management, privacy and policy management, and other aspects of the systems and methods disclosed herein. In certain embodiments, the trusted execution environment and/or SPU 1218 may operate in a logically secure processing domain and be configured to protect and operate on secret information, as described herein. In some embodiments, the trusted execution environment and/or a SPU 1218 may include internal memory storing executable instructions or programs configured to enable the SPU 1218 to perform secure operations, as described herein.

The operation of the system 1200 may be generally controlled by the processing unit 1202 and/or an SPU 1218 operating by executing software instructions and programs stored in the system memory 1204 (and/or other computer-readable media, such as memory 1208, which may be removable). The system memory 1204 may store a variety of executable programs or modules for controlling the operation of the system. For example, the system memory may include an operating system (“OS”) 1220 that may manage and coordinate, at least in part, and/or system hardware resources and provide for common services for execution of various applications.

The system memory 1204 may further include, without limitation, communication software 1222 configured to enable in part communication with and by the system, one or more applications, a cryptographic operation module 1224 configured to perform various aspects of the disclosed embodiments (e.g., cryptographic key and hash generation operations, key management operations, etc.), one or more verification digital asset and/or token management modules 1226 configured to perform various aspects of the methods disclosed herein, and/or any other information, modules, and/or applications configured to implement embodiments of the systems and methods disclosed herein.

The systems and methods disclosed herein are not inherently related to any particular computer, electronic control unit, or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network.

Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, a magnetic disk, flash memory, integrated circuits, or any other non-transitory digital processing apparatus memory device.

Although the foregoing has been described in some detail for purposes of clarity, it will be apparent that certain changes and modifications may be made without departing from the principles thereof. For example, it will be appreciated that a number of variations can be made to the various embodiments, systems, services, and/or components presented in connection with the figures and/or associated description within the scope of the inventive body of work, and that the examples presented in the figures and described herein are provided for purposes of illustration and explanation, and not limitation. It is further noted that there are many alternative ways of implementing both the systems and methods described herein. Accordingly, the present embodiments are to be considered as illustrative and not restrictive, and the embodiments of the invention are not to be limited to the details given herein, but may be modified within the scope and equivalents of the appended claims.

1. A method for managing a content asset performed by a token rights management service executing on a system comprising a processor and a non-transitory computer-readable storage medium storing instructions that, when executed by the processor, cause the system to perform the method, the method comprising:
receiving, by the token rights management service from a content rights management application associated with a first user, a first access token, identifying information relating to the first user, and identifying information relating to a content asset managed by the token rights management service;
validating the first access token with an identity and access management service of the token rights management service;
in response to validating the first access token, querying a trusted ledger service using a connector service of the token rights management service to determine whether the identifying information relating to the first user of the content rights management application is securely associated with the identification information relating to the content asset in a trusted ledger maintained by the trusted ledger service, the trusted ledger service executing on a separate system than the system executing the token rights management service;
receiving, by the connector service from the trusted ledger service, a first indication, the first indication indicating that the identifying information relating to the first user of the content rights management application is securely associated with the identification information relating to the content asset in the trusted ledger;
receiving, by the token rights management service from the content rights management application, one or more parameters relating to one or more permissible uses of the content asset; and
securely associating, by the token rights management service, based on receiving the first indication, the one or more parameters relating to the one or more permissible uses of the content asset with at least the identifying information relating to the first user and the identifying information relating to the content asset in a secure database.

2. The method of claim 1, wherein the identifying information relating to the first user of the content rights management application comprises a blockchain service wallet identifier associated with the first user.

3. The method of claim 1, wherein the method further comprises:
receiving, by the token rights management service, access key information from the content rights management application;
validating the access key information; and
issuing the first access token to the content rights management application in response to validating the access key information.

4. The method of claim 1, wherein the method further comprises:
receiving, by the token rights management service, a second access token, identifying information relating to a second user, and identifying information relating to the content asset;
validating the second access token with the identity and access management service;
in response to validating the second access token, querying the trusted ledger service using the connector service to determine whether the identifying information relating to the second user is securely associated with the identification information relating to the content asset in a trusted ledger maintained by the trusted ledger service;
receiving, by the connector service from the trusted ledger service, a second indication, the second indication indicating that the identifying information relating to the second user is securely associated with the identification information relating to the content asset in the trusted ledger;
receiving, by the token rights management service, a signed indication of the one or more parameters, the signed indication comprising a cryptographic signature generated using a key associated with the second user; and
securely associating, by the token rights management service, based on receiving the second indication, the signed indication with at least the identifying information relating to the content asset in the secure database.

5. The method of claim 4, wherein the first user and the second user are the same user.

6. The method of claim 4, wherein the second user is a creator, at least in part, of the content asset.

7. The method of claim 4, wherein the second user is a rightsholder, at least in part, of the content asset.

8. The method of claim 4, wherein the first access token and the second access token each comprise the same access token.

9. The method of claim 1, wherein the identifying information relating to the second user comprises a blockchain service wallet identifier associated with the second user.

10. The method of claim 1, wherein the content asset comprises one or more of audio content, video content, text content, data content, and software content.

11. The method of claim 1, wherein the content rights management application executes on a device associated with one or more of a songwriter, a user, and an invitee.

12. The method of claim 1, wherein the content rights management application executes on a system associated with a marketplace service.

13. The method of claim 1, wherein the marketplace service executes on the same system as the token rights management service.

14. The method of claim 1, wherein the secure database is managed by a secure database service executing on a separate system than the system executing the token rights management service and the system executing the trusted ledger service.

15. The method of claim 1, wherein the trusted ledger comprises a trusted immutable distributed assertion ledger.

16. The method of claim 1, wherein the trusted ledger comprises a blockchain ledger.

17. The method of claim 1, wherein the one or more one or more parameters comprise at least one parameter relating to one or more of a sale of the content asset, a rental of the content asset, a number of available copies of the content asset, and temporal parameters relating to the one or more permissible uses of the content asset.
